(19) United States
(12) Patent Application Publication
(10) Pub. No.: US 2025/0062923 A1
(43) Pub. Date: Feb. 20, 2025

(54) DISTRIBUTED LEDGER FOR INTERNET OF THINGS

(71) Applicants: NEWSOUTH INNOVATIONS PTY LIMITED, Sydney, New South Wales (AU); THE UNIVERSITY OF SYDNEY, Sydney, New South Wales (AU)

(72) Inventors: Abubakar Sadiq SANI, Sydney, New South Wales (AU); Zhao Yang DONG, Sydney, New South Wales (AU); Dong YUAN, Sydney, New South Wales (AU); Ke MENG, Sydney, New South Wales (AU)

(21) Appl. No.: 18/709,377

(22) PCT Filed: Nov. 11, 2022
(86) PCT No.: PCT/AU2022/051346

§ 371 Date: May 10, 2024

(30) Foreign Application Priority Data
Nov. 12, 2021 (AU) 2021903632

(51) Int. Cl. H04L 9/00; G06Q 20/06

(52) U.S. Cl. CPC H04L 9/50; G06Q 20/065; G06Q 2220/00; H04L 2209/56

(57) ABSTRACT

A method, system and computer readable storage medium for controlling a state of accounts. In one aspect, the method uses a data structure storing a plurality of transactions representing the state of accounts. The method comprises receiving a request by a node of a plurality of nodes to create a transaction and determining a type of the transaction based on the request. The determined type of the transaction is used to determine whether to add the transaction to a data structure storing a plurality of transactions representing a state of accounts. In response to determining that the transaction is to be added to the data structure, storing the transaction in the data structure based on the determined type to control the state of accounts. The transaction may by stored in the data structure using a link corresponding to the determined type. The determined type corresponds to a type from a plurality of types comprising a retractable transaction and a non-retractable transaction.

### FIELD

The present invention relates generally to distributed ledger technologies, and in particular to distributed ledger technologies for Internet of Things, which comprises of a network of objects such as computing devices. The present invention also relates to a method, system, and a computer readable medium for controlling a state of accounts, and to a computer readable storage medium storing a data structure for storing a plurality of transactions representing the state of accounts.

### BACKGROUND

Cryptocurrencies have been developed as a secure decentralised alternative to traditional currencies centrally managed by local banking authorities, such as central banks, e.g., the Reserve Bank of Australia, the Reserve Banking System etc. Validity of a cryptocurrency coin is provided by a ledger, which has a timestamp for each transaction. Timestamping is typically validated using asymmetric cryptography and/or cryptographic hash functions to ensure that a transaction in the ledger cannot be altered and/or reversed after the transaction has been proven.

Prevention of changes to and/or retraction of proven transactions in the ledger is the key characteristic of typical cryptocurrency systems since otherwise integrity of the ledger would be compromised and cryptographic techniques would not function as intended. With widespread adoption of cryptocurrencies for electronic payments, there may arise situations where a transaction needs to be modified and/or retracted after being confirmed or proven in the ledger. For example, a user may want to return unwanted goods and would expect a refund. Alternatively, a user may realise that the payee details and/or an amount in the transaction are incorrect and would want to establish a new transaction to correct the incorrect details. Currently mechanisms enabling security of cryptocurrencies prevent such establishments.

Furthermore, Internet of Things (IoT)-based cryptocurrencies are now used to facilitate Machine-to-Machine (M2M) payments between IoT nodes. The term “IoT node” (or “node” for simplicity) represents entities that establish, exchange, obtain, issue, and validate transactions. The IoT industry relies on existing cryptocurrencies such as the Internet of Things Applications (IOTA) and IoTeX to process payments. The IOTA uses the tangle technology for storing transactions and the IoTeX works with the blockchain technology.

The tangle and the blockchain technologies suffer from inherent drawbacks of (online) key generators and Proof of Work (PoW) thereby exposing the IOTA and the IoTeX system to security attacks such as Distributed Denial of Service (DDOS) attacks. Furthermore, the IOTA and the IoTeX utilise static private keys for transactions thereby increasing the risk of funds theft due to compromised static private keys. Additional issues with existing IoT cryptocurrencies are a) the lengthy waiting time for transaction confirmation and b) single point of failure via centralised authorities. Specifically, a new transaction is required to select and confirm two existing unconfirmed transactions on the tangle in the IOTA thereby introducing computational complexities of confirming two transactions by resource-constrained or low-powered IoT nodes.

The IOTA also uses a coordinator, i.e., a centralised authority, to ensure the IOTA's network security. Reliance on the coordinator as a form of security affects reliability of the IOTA and hinders full decentralisation, which is one of the main features of cryptocurrency systems. In the attempt to improve decentralisation, some cryptocurrency systems adopted voting mechanisms intended to decide which transactions to be included in the tangle. However, such voting mechanisms are susceptible to multiple points of failures. One example of a system utilising a voting mechanism is the IOTA's coordicide solution. The coordicide solution was introduced to solve coordinator's issues. The coordicide solution, however, relies on the availability of other IoT nodes and introduces high computational complexities, which are not suitable for resource-constrained or low-powered IoT nodes.

Moreover, the combination of M2M payment and non-payment functionalities, e.g., micropayments and data processing, do not exist in the tangle and blockchain setups. Furthermore, due to design and data structure of the tangle and blockchain, it is not possible to support reversible payments or micropayments. As such, privacy-preserving and choice-based retractable transactions are not supported in existing cryptocurrency systems.

Accordingly, a need exists for a system where transactions can be retracted without compromising security and violating integrity of the ledger within the system.

### SUMMARY

It is an object of the present invention to substantially overcome, or at least ameliorate, one or more disadvantages of existing arrangements.

In one aspect there is provided a method of controlling a state of accounts using a data structure storing a plurality of transactions representing the state of accounts, the method comprising: receiving a request by a node of a plurality of nodes to create a transaction; determining a type of the transaction based on the request; determining, based on the determined type, whether to add the transaction to a data structure storing a plurality of transactions representing a state of accounts; and in response to determining that the transaction is to be added to the data structure, storing the transaction in the data structure based on the determined type to control the state of accounts, wherein the transaction is stored in the data structure using a link corresponding to the determined type, the determined type corresponding to a type from a plurality of types comprising a retractable transaction and a non-retractable transaction.

In certain embodiment, the transaction is added to the data structure in association with the determined type to control the state of accounts, wherein the transaction is added to the data structure using a Distributed Consensus-based Key Establishment protocol if the transaction is either a retractable transaction or a non-retractable transaction.

In certain embodiments, the method further comprises utilizing the transaction without being added to the data structure if the determined type is a non-payment functionality transaction, wherein the non-payment functionality transaction is utilised using a Non-Consensus-based Key Establishment protocol.

In certain embodiments, the method further comprises: receiving a further request by the node to convert a retractable transaction from the plurality of transactions in the data structure to a non-retractable transaction; identifying the retractable transaction in the data structure using the received further request; adding a further non-retractable transaction associated with the identified transaction to the data structure using the Distributed Consensus-based Key Establishment protocol.

In certain embodiments, the method further comprises: receiving a retracting request by the node to retract a transaction in the data structure; identifying a transaction in the data structure based on the retracting request; determining if the identified transacting is retractable; retracting the transaction from the data structure if the transaction is retractable; and providing feedback to indicate to the node that the transaction is not retractable if the transaction is non-retractable.

In certain embodiments, a non-retractable transaction is associated with a directional link in the data structure and a retractable transaction is associated with a non-directional link in the data structure.

In certain embodiments, each transaction from the plurality of transactions is associated with a transaction weight value and each link connecting two transactions is associated with a link weight value.

In certain embodiments, the transaction weight value represents a total amount of work carried to process the respective transaction; and wherein the link weight value is based on the transaction weight value associated with at least one the transactions connected by said link.

In certain embodiments, the method further comprises determining a tip of the data structure to attach the transaction.

In certain embodiments, the tip is determined based on Fuzzy Analytic Hierarchy Process (AHP).

In certain embodiments, each request comprises generating a mutually authenticated key based on a key establishment protocol selected based on the determined type of the transaction.

In certain embodiments, the data structure is an Acyclic Mixed Graph.

In certain embodiments, at least one of the plurality of nodes is an Internet of Things node.

In certain embodiments, the plurality of transactions comprises at least one payment-related transaction and at least one of identity creation transaction and identity revocation transaction.

In another aspect there is provided a computer implemented system for controlling a state of accounts using a data structure storing a plurality of transactions representing the state of accounts, wherein the computer implemented system includes one or more processors configured to perform the method of the above aspect.

In a further aspect there is provided a computer readable medium including executable instructions which configured one or more processors of a computer implemented system to control a state of accounts using a data structure storing a plurality of transactions representing the state of accounts, wherein execution of the executable instructions by the one or more processors configure the computerised system to perform the method of the above aspect.

In another aspect there is provided a computer readable storage medium storing a data structure for storing a plurality of transactions representing the state of accounts, the data structure comprising: a root; and a plurality of tips, each tip corresponding to a transaction from the plurality of transactions, the plurality of tips comprising a non-retractable tip representing a non-retractable transaction and a retractable tip representing a retractable transaction, wherein the non-retractable tip is linked, using a non-retractable link to a first further tip from the plurality of tips and the retractable tip is linked using an retractable link to a second further tip from the plurality of tip, wherein the data structure is configured to enable establishment of a further non-retractable link for the retractable link associated with the retractable tip in response to a request to convert the retractable transaction to a non-retractable transaction.

In certain embodiments, a Distributed Consensus-based Key Establishment Protocol is used for adding transactions to the data structure based on a transaction type and a Non-Consensus-based Key Establishment protocol is used for exchanging transaction without adding to the data structure.

In certain embodiments, each tip is configured to have up to two child tips.

In a further aspect there is provided a method of controlling a state of accounts using a data structure storing a plurality of transactions representing the state of accounts, the method comprising: receiving a request by a node of a plurality of nodes to add a transaction to a data structure storing a plurality of transactions representing a state of accounts; determining a type of the transaction based on the request; and adding the transaction in the data structure based on the determined type to control the state of accounts, wherein the transaction is added to the data structure using a link corresponding to the determined type, the determined type corresponding to a type from a plurality of types comprising a retractable transaction and a non-retractable transaction.

Other aspects are also disclosed.

### BRIEF DESCRIPTION OF DRAWINGS

FIGS. 1A and 1B collectively form a schematic block diagram representation of an electronic device upon which described arrangements can be practiced;

FIG. 2 shows a data structure for storing a plurality of transactions representing a state of accounts in accordance with one embodiment of the present invention;

FIG. 3 depicts a data structure for storing a plurality of transactions representing a state of accounts in accordance with another embodiment of the present invention;

FIG. 4 shows a list of available tips and a timestamp for adding a new transaction in accordance with one embodiment of the present invention;

FIG. 5 shows a list of available tips and a timestamp for retracting a pseudo transaction in accordance with one embodiment of the present invention;

FIG. 6 schematically illustrates high level details of F-AHP in accordance with one embodiment of the present invention;

FIG. 7 demonstrates a process of adding a new transaction to a braid in accordance with one embodiment of the present invention;

FIG. 8 shows an example double spending attach scenario;

FIGS. 9A and 9B illustrate a splitting attack scenario;

FIG. 10 shows a parasite chain attack scenario;

FIG. 11 depicts a method of controlling a state of accounts in accordance with one embodiment of the present invention;

FIG. 12 shows a method of processing a request from a node in accordance with one embodiment of the present invention;

FIG. 13 illustrates a method of selecting an attachment tip in accordance with one embodiment of the present invention;

FIG. 14A shows a method of controlling a state of accounts in accordance with another embodiment of the present invention; and

FIG. 14B shows a flow chart of a method in accordance with one implementation of the method shown in FIG. 14A.

### DESCRIPTION OF EMBODIMENTS

Where reference is made in any one or more of the accompanying drawings to steps and/or features, which have the same reference numerals, those steps and/or features have for the purposes of this description the same function(s) or operation(s), unless the contrary intention appears.

Embodiments of the present disclosure relate to an innovative secure, efficient, and privacy-preserving cryptocurrency technology for IoT (herein “Cryptiot”). Cryptiot is based on a novel distributed ledger technology (herein “braid”), instead of the blockchain or the tangle technology. The braid is specifically designed for the IoT industry for M2M payment and non-payment transactions. However, it can be appreciated that the braid has wide applicability and can be used in other industries. The braid is a scalable distributed ledger technology that supports payment and non-payment functionality-based actual and pseudo transactions without trusted parties or coordinators. A key establishment protocol is used to reach a distributed consensus on the braid and an F-AHP algorithm is introduced as a strategy for hierarchically selecting a tip and attaching a new transaction to the selected tip in the braid.

The braid is an Acyclic Mixed Graph (AMG) for storing transactions that represent a distributed ledger. The braid offers features to establish and retract Machine-to-Machine (M2M) payment and non-payment functionalities transactions. For the purposes of this disclosure, micropayments in the IoT are considered to be M2M payment transactions. Non-payment transactions typically relate to data processing in the IoT.

The present disclosure proposes to have actual and pseudo transactions for the M2M payment and non-payment functionalities. Actual transactions are non-retractable transactions. Pseudo transactions can be retracted after they have been executed or processed/implemented by the IoT nodes that issued such transactions.

If there is a directed link between a new transaction and an existing transaction in the AMG, the new transaction is an actual transaction. Otherwise, if there is an undirected link between a new transaction and an existing transaction in the AMG, the new transaction is a pseudo transaction. The pseudo transactions are advantageous when dealing with transaction owner factors including change of mind and purpose.

Each transaction typically contains transaction data (TData). The transaction data may comprise a transaction message, a transaction type, a transaction weight, a transaction value, a transaction tag, a sender associated with the transaction, and a receiver associated with the transaction. The transaction data is used for distinguishing transactions in Cryptiot. For transactions with similar transaction data, the tag is a unique attribute for simplifying the identification of the transactions.

To prevent fraudulent, illegal and other related transactions as well as misinformation, Cryptiot may use a key establishment module for verifying identity and authenticity of nodes and transactions before reaching consensus. The key establishment module can provide mutual authentication, key confirmation, and key secrecy. In other words, the key establishment module may guarantee that a secret key is shared between two intended IoT nodes, that the IoT nodes share the same secret key, and no other node knows about the key. The key establishment module may implement a distributed consensus-based key functionality protocol (DC-KEP) and a non-consensus-based key establishment protocol (NC-KEP). The DC-KEP may be used by the IoT nodes for reaching a distributed consensus on the braid. The NC-KEP may be used for securely exchanging transactions, for example, retractable transactions.

In the Cryptiot network, every IoT node is aware of different types of transactions, such as actual and pseudo transactions, and that the actual transactions are non-retractable and the pseudo transactions are retractable. The Cryptiot network may also comprise two different types of nodes: i) IoT nodes; and ii) distributed master nodes (or distributed servers). The distributed master nodes may be owned by founders of the braid, i.e. the Cryptiot network. The distributed master nodes may be responsible for registering and enrolling new IoT nodes to the Cryptiot network. Additionally, the distributed master nodes maintain a copy of the braid, e.g. the AMG for storing the transactions, and have all the capabilities of the IoT nodes as described above. Each of the distributed master nodes may maintain a distributed database for storing the braid.

The Cryptiot network may be asynchronous, i.e. different nodes may see a different set of transactions at a given time. For brevity and unless otherwise stated, the term “node” refers to both IoT nodes and distributed master nodes.

In general, Cryptiot is a braid-based cryptocurrency. The IoT nodes of the Cryptiot network issue transactions that are stored on the braid that represents a distributed ledger. The DC-KEP is used to reach a distributed consensus on the braid and to obtain details of tips of the braid when a new transaction arrives. The term “tip” represents a transaction with less than two other transactions attached to it in the braid, the order of a tip node in the braid is less than two.

As discussed above, if there is a directed link between the new transaction (say, I) and an existing transaction (say, G), I is considered to be an actual transaction, if it is an undirected link, I is considered to be a pseudo transaction. A genesis transaction (say, A) may represent first transaction in the braid. The genesis transaction may be generated by first founder of the braid. Cryptiot tokens may be distributed to several other founders of the braid by the first founder via the genesis transaction. Every Cryptiot token is used to transact value in the braid and can be freely traded on many public digital asset exchanges. The Cryptiot token are sold via the founders under a Cryptiot Foundation. As Cryptiot does not require mining like in Bitcoin, no founder receives any monetary rewards.

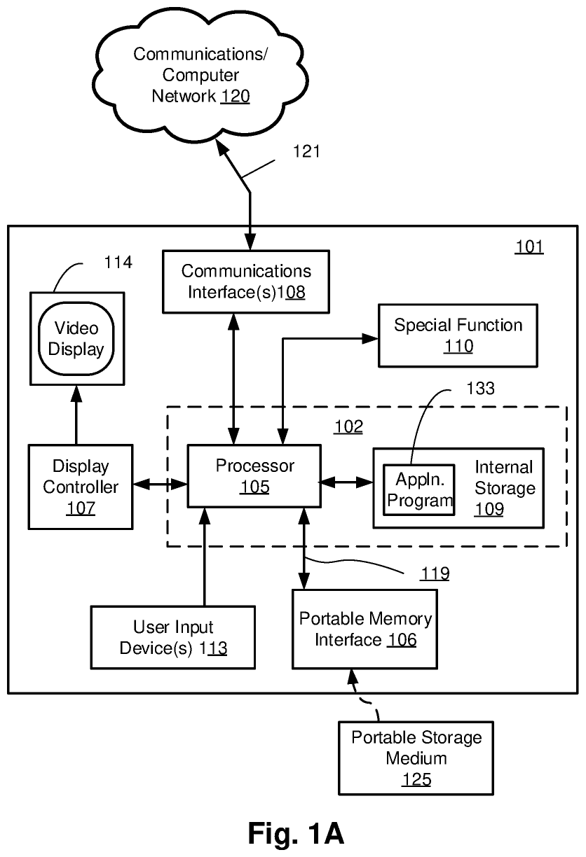

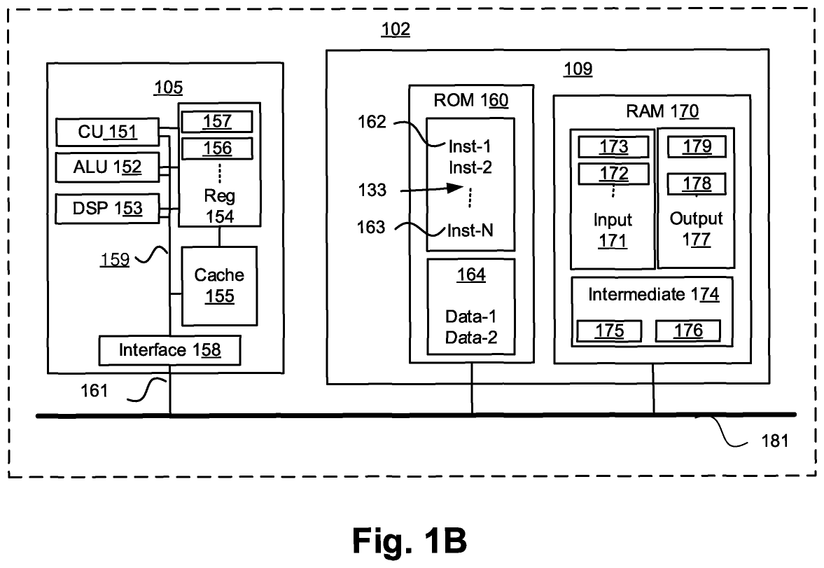

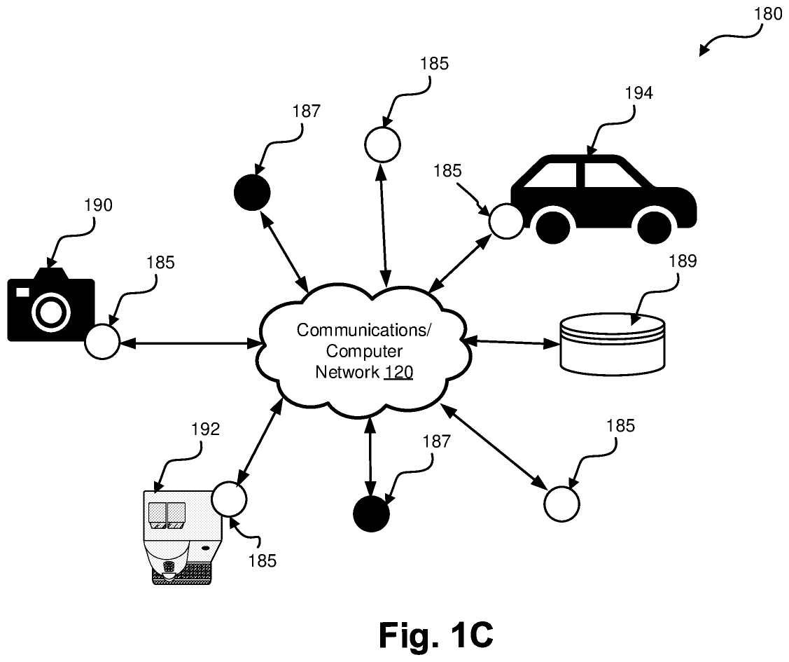

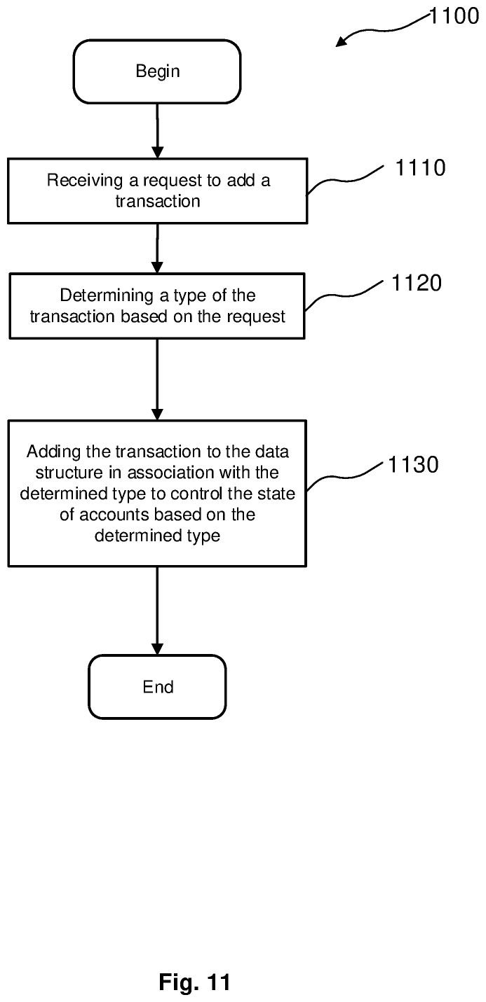

FIGS. 1A and 1B collectively form a schematic block diagram of a general purpose electronic device 101 including embedded components, upon which the methods shown in FIGS. 11-13 to be described are desirably practiced. The electronic device 101 may be, for example, an IoT device, a mobile phone, a portable media player or a digital camera, in which processing resources are limited. Nevertheless, the methods to be described may also be performed on higher-level devices such as desktop computers, server computers, and other such devices with significantly larger processing resources.

As seen in FIG. 1A, the electronic device 101 comprises an embedded controller 102. Accordingly, the electronic device 101 may be referred to as an “embedded device.” In the present example, the controller 102 has a processing unit (or processor) 105 which is bi-directionally coupled to an internal storage module 109. The storage module 109 may be formed from non-volatile semiconductor read only memory (ROM) 160 and semiconductor random access memory (RAM) 170, as seen in FIG. 1B. The RAM 170 may be volatile, non-volatile or a combination of volatile and non-volatile memory.

The electronic device 101 includes a display controller 107, which is connected to a video display 114, such as a liquid crystal display (LCD) panel or the like. The display controller 107 is configured for displaying graphical images on the video display 114 in accordance with instructions received from the embedded controller 102, to which the display controller 107 is connected.

The electronic device 101 may also include user input devices 113 which are typically formed by keys, a keypad or like controls. In some implementations, the user input devices 113 may include a touch sensitive panel physically associated with the display 114 to collectively form a touch-screen. Such a touch-screen may thus operate as one form of graphical user interface (GUI) as opposed to a prompt or menu driven GUI typically used with keypad-display combinations. Other forms of user input devices may also be used, such as a microphone (not illustrated) for voice commands or a joystick/thumb wheel (not illustrated) for ease of navigation about menus.

As seen in FIG. 1A, the electronic device 101 also comprises a portable memory interface 106, which is coupled to the processor 105 via a connection 119. The portable memory interface 106 allows a complementary portable memory device 125 to be coupled to the electronic device 101 to act as a source or destination of data or to supplement the internal storage module 109. Examples of such interfaces permit coupling with portable memory devices such as Universal Serial Bus (USB) memory devices, Secure Digital (SD) cards, Personal Computer Memory Card International Association (PCMIA) cards, optical disks and magnetic disks.

The electronic device 101 also has a communications interface 108 to permit coupling of the device 101 to a computer or communications network 120 via a connection 121. The connection 121 may be wired or wireless. For example, the connection 121 may be radio frequency or optical. An example of a wired connection includes Ethernet. Further, an example of wireless connection includes Bluetooth™ type local interconnection, Wi-Fi (including protocols based on the standards of the IEEE 802.11 family), Infrared Data Association (IrDa) and the like.

Typically, the electronic device 101 is configured to perform some special function. The embedded controller 102, possibly in conjunction with further special function components 110, is provided to perform that special function. For example, where the device 101 is a digital camera, the components 110 may represent a lens, focus control and image sensor of the camera. The special function components 110 is connected to the embedded controller 102. As another example, the device 101 may be a mobile telephone handset. In this instance, the components 110 may represent those components required for communications in a cellular telephone environment. Where the device 101 is an IoT device, the components 110 may represent sensors sensing a relevant signal and sending the signal to another electronic device 101 across the communications network 120 via a connection 121.

The methods described hereinafter may be implemented using the embedded controller 102, where the processes of FIGS. 11 to 13 may be implemented as one or more software application programs 133 executable within the embedded controller 102. The electronic device 101 of FIG. 1A implements the described methods. In particular, with reference to FIG. 1B, the steps of the described methods are effected by instructions in the software 133 that are carried out within the controller 102. The software instructions may be formed as one or more code modules, each for performing one or more particular tasks. For example, code modules of the electronic IoT device 101 may include a cryptographic code module configured to execute cryptographic functions discussed below. The software may also be divided into two separate parts, in which a first part and the corresponding code modules performs the described methods and a second part and the corresponding code modules manage a user interface between the first part and the user.

The software 133 of the embedded controller 102 is typically stored in the non-volatile ROM 160 of the internal storage module 109. The software 133 stored in the ROM 160 can be updated when required from a computer readable medium or from the communications network 120. The software 133 can be loaded into and executed by the processor 105. In some instances, the processor 105 may execute software instructions that are located in RAM 170. Software instructions may be loaded into the RAM 170 by the processor 105 initiating a copy of one or more code modules from ROM 160 into RAM 170. Alternatively, the software instructions of one or more code modules may be pre-installed in a non-volatile region of RAM 170 by a manufacturer. After one or more code modules have been located in RAM 170, the processor 105 may execute software instructions of the one or more code modules.

The application program 133 is typically pre-installed and stored in the ROM 160 by a manufacturer, prior to distribution of the electronic device 101. However, in some instances, the application programs 133 may be supplied to the user encoded on one or more CD-ROM (not shown) and read via the portable memory interface 106 of FIG. 1A prior to storage in the internal storage module 109 or in the portable memory 125. In another alternative, the software application program 133 may be read by the processor 105 from the network 120, or loaded into the controller 102 or the portable storage medium 125 from other computer readable media. Computer readable storage media refers to any non-transitory tangible storage medium that participates in providing instructions and/or data to the controller 102 for execution and/or processing. Examples of such storage media include floppy disks, magnetic tape, CD-ROM, a hard disk drive, a ROM or integrated circuit, USB memory, a magneto-optical disk, flash memory, or a computer readable card such as a PCMCIA card and the like, whether or not such devices are internal or external of the device 101. Examples of transitory or non-tangible computer readable transmission media that may also participate in the provision of software, application programs, instructions and/or data to the device 101 include radio or infra-red transmission channels as well as a network connection to another computer or networked device, and the Internet or Intranets including e-mail transmissions and information recorded on Websites and the like. A computer readable medium having such software or computer program recorded on it is a computer program product.

The second part of the application programs 133 and the corresponding code modules mentioned above may be executed to implement one or more graphical user interfaces (GUIs) to be rendered or otherwise represented upon the display 114 of FIG. 1A. Through manipulation of the user input device 113 (e.g., the keypad), a user of the device 101 and the application programs 133 may manipulate the interface in a functionally adaptable manner to provide controlling commands and/or input to the applications associated with the GUI(s). Other forms of functionally adaptable user interfaces may also be implemented, such as an audio interface utilizing speech prompts output via loudspeakers (not illustrated) and user voice commands input via the microphone (not illustrated).

FIG. 1B illustrates in detail the embedded controller 102 having the processor 105 for executing the application programs 133 and the internal storage 109. The internal storage 109 comprises read only memory (ROM) 160 and random access memory (RAM) 170. The processor 105 is able to execute the application programs 133 stored in one or both of the connected memories 160 and 170. When the electronic device 101 is initially powered up, a system program resident in the ROM 160 is executed. The application program 133 permanently stored in the ROM 160 is sometimes referred to as “firmware”. Execution of the firmware by the processor 105 may fulfil various functions, including processor management, memory management, device management, storage management and user interface.

The processor 105 typically includes a number of functional modules including a control unit (CU) 151, an arithmetic logic unit (ALU) 152, a digital signal processor (DSP) 153 and a local or internal memory comprising a set of registers 154 which typically contain atomic data elements 156, 157, along with internal buffer or cache memory 155. One or more internal buses 159 interconnect these functional modules. The processor 105 typically also has one or more interfaces 158 for communicating with external devices via system bus 181, using a connection 161.

The application program 133 includes a sequence of instructions 162 though 163 that may include conditional branch and loop instructions. The program 133 may also include data, which is used in execution of the program 133. This data may be stored as part of the instruction or in a separate location 164 within the ROM 160 or RAM 170.

In general, the processor 105 is given a set of instructions, which are executed therein. This set of instructions may be organised into blocks, which perform specific tasks or handle specific events that occur in the electronic device 101. Typically, the application program 133 waits for events and subsequently executes the block of code associated with that event. Events may be triggered in response to input from a user, via the user input devices 113 of FIG. 1A, as detected by the processor 105. Events may also be triggered in response to other sensors and interfaces in the electronic device 101.

The execution of a set of the instructions may require numeric variables to be read and modified. Such numeric variables are stored in the RAM 170. The disclosed method uses input variables 171 that are stored in known locations 172, 173 in the memory 170. The input variables 171 are processed to produce output variables 177 that are stored in known locations 178, 179 in the memory 170. Intermediate variables 174 may be stored in additional memory locations in locations 175, 176 of the memory 170. Alternatively, some intermediate variables may only exist in the registers 154 of the processor 105.

The execution of a sequence of instructions is achieved in the processor 105 by repeated application of a fetch-execute cycle. The control unit 151 of the processor 105 maintains a register called the program counter, which contains the address in ROM 160 or RAM 170 of the next instruction to be executed. At the start of the fetch execute cycle, the contents of the memory address indexed by the program counter is loaded into the control unit 151. The instruction thus loaded controls the subsequent operation of the processor 105, causing for example, data to be loaded from ROM memory 160 into processor registers 154, the contents of a register to be arithmetically combined with the contents of another register, the contents of a register to be written to the location stored in another register and so on. At the end of the fetch execute cycle the program counter is updated to point to the next instruction in the system program code. Depending on the instruction just executed this may involve incrementing the address contained in the program counter or loading the program counter with a new address in order to achieve a branch operation.

Each step or sub-process in the processes of the methods described below is associated with one or more segments of the application program 133, and is performed by repeated execution of a fetch-execute cycle in the processor 105 or similar programmatic operation of other independent processor blocks in the electronic device 101.

FIG. 1C schematically shows an Internet-of-Things (IoT) network 180 where the discussed arrangements can be practiced. The IoT network 180 comprises a plurality of common IoT devices 185, a plurality of distributed master devices 187 and a distributed database 189. The devices 185 and 187 are also referred to as nodes. The nodes 185 and 187 may have similar configuration as the electronic device 101 discussed above. The nodes 185 and 187 may communicate with each other and access the database 189 via the communications network 120. An IoT node may be associated with a corresponding special purpose device, such as a photo/video camera 190, a coffee machine 192, a vehicle 194, a refrigerator (not shown), an air-conditioner (not shown) or the like. Alternatively, an IoT node may be stand alone.

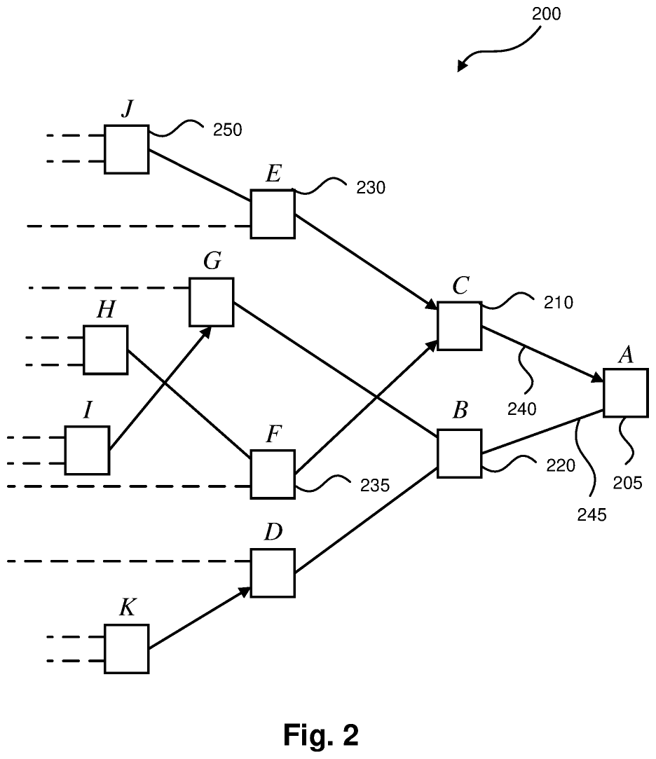

FIG. 2 depicts a portion of the braid 200 in accordance with some implementations of the present disclosure. The braid 200 may be stored in memory 109 of the distributed database 189. The boxes 205, 210, 220 and 230 represent transactions. A root transaction 205 in the braid 200 is referred to as a genesis transaction. A transaction with a directed link or arrow 240 to other transactions is an actual transaction. For example, transactions 210 and 230 are considered to be actual transactions. A transaction with an undirected link to other transactions and without a directed link to other transactions is a pseudo transaction. For example, a transactions 220 is considered to be pseudo transactions.

According to the present disclosure, the IoT nodes are configured to establish, exchange, obtain, issue, validate, and retract transactions in Cryptiot using the key establishment module. The key establishment module provides shared secret keys for securing actual or pseudo transactions. Each transaction can be either payment or non-payment functionality-based transactions. The key establishment module also provides a tips pointer for validating tips in the braid and a verifier upon reaching consensus. The key establishment module contributes to the security of the braid and the Cryptiot network. Additionally, the key establishment module prevents acceptance of a double-spending transaction by validating the transactions (discussed below). The key establishment module uses the tips pointer and verifier to mitigate the risk of selecting any conflicting or unvalidated tip for attachment on the braid. A transaction is considered to be conflicting if transaction data is similar to another existing transaction in the braid. An unvalidated transaction is a transaction which has not been validated yet by any distributed master node. Each conflicting or unvalidated transaction is not associated with valid tips pointer or verifier. Even though conflicting and unvalidated transactions can be in the braid, such transactions are not chosen as tips for attachments. Neither can conflicting and unvalidated transactions be used by the IoT nodes (discussed in more details below).

To attach a new transaction, the IoT nodes can choose their preferred attachment strategy and location on the braid using a Fuzzy-Analytical Hierarchical Process (F-AHP). An IoT node may have a set of criteria for attachment new transactions. If an IoT node does not have any criterion for attaching new transactions, the IoT node can use a default F-AHP criterion. For example, the default F-AHP criterion can be a transaction type (without loss of generality). The F-AHP is discussed in more detail below.

If an IoT node finds a location in the braid to be conflicting with the criteria specific to that IoT node based on a transaction type, weight, or address, the IoT node selects not to use that conflicting location in the braid for either an actual or a pseudo transaction. For the purposes of the present disclosure, the term “location” refers to a tip in the braid and the term “address” represents an account that belongs to an IoT node and can be used to send or receive Cryptiot currency also referred to as tokens. In other words, an IoT node selects an attachment strategy and a location for attaching a new transaction. The F-AHP contributes to accelerating the decision-making process of the IoT node, i.e. facilitates selection of the attachment strategy and the location. In some implementations, an IoT node can finalise the F-AHP at the end of every step of the F-AHP to further enhance performance of the Cryptiot network.

A strategy for attaching a new transaction to the braid can be selected from a plurality of strategies. To issue a new transaction and further mitigate spamming and other related attacks, every node may go through a tip selection process to select a tip in the braid (mixed acyclic graph) and attach the new transaction to the selected tip. Any validated tip in the braid can be selected as a place for a new transaction attachment since the importance of all validated tips in the braid are equal by default.

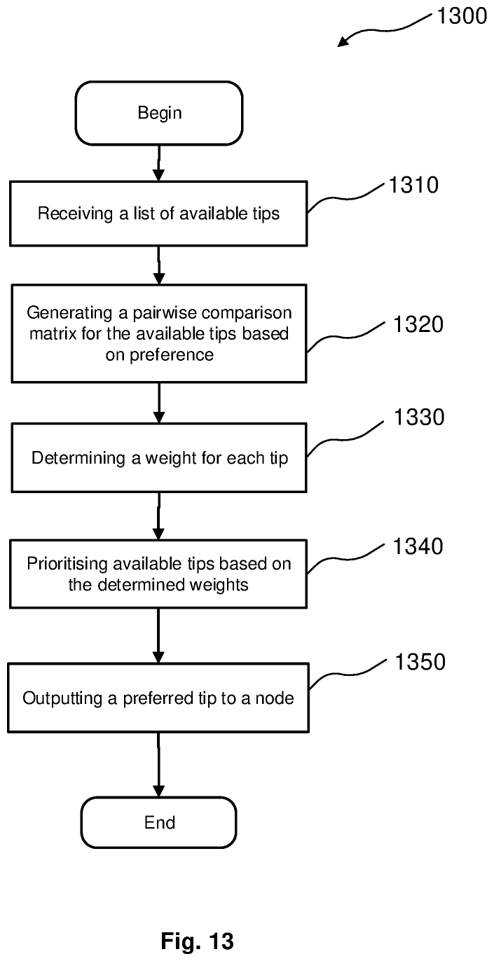

The F-AHP may be further configured to make a choice by hierarchically selecting a validated tip from among several validated tips. The tip can be selected based on essential metrics such as transaction type, weight, and address. The F-AHP algorithm effectively makes it possible to compare and organise the essential metrics by determining the impact the metrics have on one another according to preferences of a particular node and deriving priorities for alternatives based on the determined impact. Accordingly, the F-AHP allows a node to find the best tip based on preferences of the particular node. Specifically, the F-AHP provides a list of validated tips ordered in accordance with priorities derived from preferences of an IoT node which allows hierarchical selection of a validated tip for attaching a new transaction. As such, the F-AHP is advantageously based on preferences of a particular node as well as improves and simplifies decision-making during the tip selection. The F-AHP is described in more detail with references to FIG. 13.

FIG. 2 shows a data structure for storing a plurality of transactions representing a state of accounts in a form of braid 200. The data structure is referred to as a braid hereinafter for the purposes of the present disclosure. The data structure 200 can be stored in a computer readable storage medium, for example, in memory 109 of the electronic device 101. The data structure comprises a root, for example, a root A 205, and a plurality of tips, for example, tips 210, 220, 230. Each tip 210-230 corresponds to a transaction from the plurality of transactions. Each tip may be configured to have up to two child tips. The plurality of tips comprises a non-retractable tip, for example, a tip C 210, representing a non-retractable transaction and a retractable tip, for example, a tip B 220, representing a retractable transaction.

The non-retractable tip, e.g. 210, is linked using a directed link, e.g. 240, to a first further tip from the plurality of tips or the root, e.g. 205. The retractable tip, e.g. 220, is linked using an undirected link, e.g. 245, to a second further tip from the plurality of tips or the root, e.g. 205. As such, the first further tip can be the same as the second further tip. Alternatively the first further tip and the second further tip can be different.

The data structure 200 is configured to enable establishment of a directed link for an existing undirected link, e.g. 245, associated with the retractable tip, e.g. 220, in response to a request to establish a non-retractable transaction associated with the retractable transaction. For example, in response to receiving a command to establish a non-retractable transaction to a retractable transaction and subject to successful execution of the Distributed Consensus-based key establishment protocol, a new non-retractable transaction with a directional link can be established in the braid. In other words, a retractable transaction can be converted to a non-retractable transaction by adding a new non-retractable transaction to the braid. The new transaction may be added using a tip selection protocol discussed below. Transaction data of the new non-retractable transaction associated with the original retractable transaction may include ID of the retractable transaction so that the original retractable transaction can be identified. In some implementations, the new non-retractable transaction may be for the same amount as the original retractable transaction. Alternatively, the non-retractable transaction may be for a different amount. For example, a parking fee payment may be originally collected using a retractable transaction for a default parking amount, e.g. 1 hour. Upon existing a parking lot, the retractable transaction can be converted to a non-retractable transaction specifying parking fee corresponding to exact parking time, e.g. 1 hour, 30 mins, or 5 hours.

The retractable tips can be added to the data structure 200 using a Distributed-Consensus-based Key Establishment protocol and the non-retractable tips can be added to the data structure 200 using the Distributed Consensus-based Key Establishment protocol. For example, if a node would like to add a retractable transaction, the node may execute the DC-KEP with one of the distributed master nodes to add the retractable tip to any available tips in the braid. If a node would like to add a non-retractable transaction, the node may execute the DC-KEP with one of the distributed master nodes which grants a tips pointer and a verifier for the non-retractable transaction in response to successful mutual authentication.

Transactions related to non-payment functionality, for example file transfers, are processed by executing a Non-Consensus-based Key Establishment protocol (NC-KEP) with another party of the non-payment transaction. In same implementations, a record related to the non-payment transaction, e.g. a file transfer, rather than the transaction itself, e.g. a transferred file, may be stored in the braid. The non-payment transaction may not have a verifier and, accordingly, the non-payment transactions are not added to the braid. Validity of the retractable transaction is enabled by mutual agreement between the parties in the retractable transaction which is facilitated by the NC-KEP. The Non-Consensus-based Key Establishment protocol (NC-KEP) and the Consensus-based Key Establishment protocol (DC-KEP) are described below.

According to some implementations of the present disclosure, every transaction can be attached to only one transaction and each transaction can have up to two transactions attached to that transaction, i.e. up to two child transactions. For example, with references to FIG. 2, transaction C 210 in the braid 200 can be attached to only one transaction, e.g. transaction A 205. Furthermore, transaction C 210 can only have a maximum of two transactions, e.g. E 230 and F 235, attached to transaction C 210. Thus, two new transactions can be attached to a tip (for example, tip J 250 in FIG. 2) in the braid 200.

In general, with every new transaction added in the braid 200, two tips become available for every further transaction to support the scalability of the ledger. In the braid 200, actual or non-retractable transactions are associated with a directed link while pseudo or retractable transactions are associated with an undirected link. For example, the actual transaction may be attached to a tip using a directed links and a pseudo transaction may be attached to the tip using an undirected link. Specifically, in FIG. 2, transactions C, E, F, K, and/are actual transactions while transactions B, D, J, and H are pseudo-transactions.

FIG. 11 shows a method 1100 of controlling a state of accounts in accordance with one implementation of the present disclosure. The method 1100 uses a data structure, for example, an Acyclic Mixed Graph such as the braid 200, storing a plurality of transactions, for example, 210-235 and 250, representing the state of accounts. The plurality of transactions may comprise at least one payment-related transaction and at least one non-payment related transaction. The method 1100 may be executed on a processor 105 of a master distributed node 187 or a common IoT node 185 under control of instructions stored in memory 109.

The method 1100 commences at a step 1110 of receiving a request to add a transaction to the data structure, e.g. the braid 200. The request may be received by a node, for example, an IoT node 185 associated with the device 192, of a plurality of nodes. The request may include a transaction type. In some implementations, the request also includes additional metadata for the transaction, such as transaction amount, transaction functionality, parties involved in the transaction and the like. The transaction type can be an actual (non-retractable) transaction or a pseudo (retractable) transaction. The transaction type may be selected by the node sending the request to add the transaction. Transaction functionality may specify whether the transaction relates to payment or non-payment functionality.

Step 1110 continues to a step 1120 of determining a type of the transaction based on the request. For example, the request can be parsed to extract the type of the transaction from the request. The type can be determined as a retractable transaction type or a non-retractable transaction type.

The method 1100 proceeds from step 1120 to a step 1130 of adding the transaction to the data structure in association with the determined type to control the state of accounts based on the determined type. If the transaction is a retractable payment transaction, the transaction is added to the data structure, e.g. the braid 200, using a retractable link based on a Distributed Consensus-based Key Establishment protocol (DC-KEP) described below. If the transaction is a non-retractable payment transaction, the transaction is added to the data structure, e.g. the braid 200, using a non-retractable link based on DC-KEP described below. If the transaction is a non-payment transaction, the transaction is not added to the data structure and confirmed by executing a Non-Consensus-based key establishment protocol between relevant parties to the non-payment transaction.

The retractable transaction is added to the data structure using a ‘retractable’ link, e.g. an undirected link, while a non-retractable transaction is added to the data structure using a ‘non-retractable’ link, e.g. a directed link. For the purposes of the present disclosure, the terms ‘retractable’ and ‘non-retractable’ are used merely to distinguish links for attaching retractable and non-retractable transactions. It is noted that the retractable links and non-retractable links are intended to be different, i.e. have different properties. In some implementations, a retractable link is non-directed while a non-retractable link is directed. In alternative implementations, retractable and non-retractable links may be distinguished based on tags or other metadata stored for the links.

For example, if the request relates to adding a retractable payment transaction, the node issuing the transaction may execute the DC-KEP with one of the distributed master nodes to add a retractable tip to any available tips in the braid. If a transaction is not to be added to the data structure, the node can execute the Non-Consensus-based Key Establishment protocol (NC-KEP) with another node. If the request relates to adding a non-retractable transaction, the node issuing the transaction may execute the DC-KEP with one of the distributed master nodes which grants a tips pointer and a verifier for the non-retractable transaction in response to successful mutual authentication.

The method 1100 concludes on completion of step 1130.

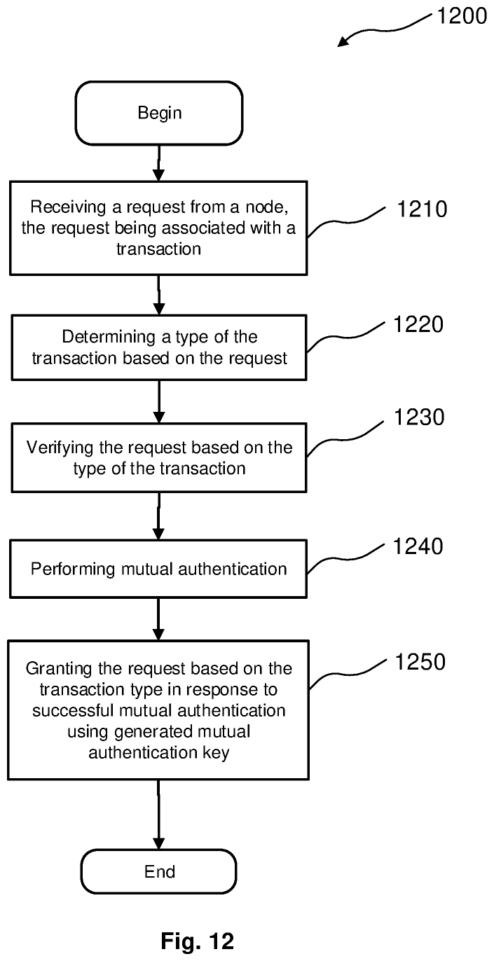

Retractable transactions can be further converted, on request, to actual transactions. In some implementations, a retractable transaction is converted to a non-retractable transaction by updating an un-directional link, e.g. 245, between the retractable transaction, e.g. 220, and the parent transaction, e.g. 205, to a directional link subject to successful execution of the DC-KEP. As discussed in in more detail with references to FIG. 12, the method 1100 may further include steps of receiving a further request from the node to convert a retractable transaction from the plurality of transactions in the data structure to a non-retractable transaction, identifying the retractable transaction in the data structure using the received further request, and adding a further non-retractable transaction associated with the identified transaction to the data structure, e.g. the braid 200, using the Distributed Consensus-based Key Establishment protocol.

To retract a transaction, a distributed master node may receive a retracting request from the node to retract a transaction in the data structure. In some implementations, only a node which created a retractable transaction may request retraction of that transaction. In response to receiving the retracting request, the distributed master node proceeds to identifying a transaction in the data structure based on the retracting request, determining if the identified transacting is retractable, retracting the transaction from the data structure if the transaction is retractable, and providing feedback to indicate to the node that the transaction is not retractable if the transaction is non-retractable. A retractable transaction can be retracted by adding a new non-retractable transaction to the braid to specify the retraction. The new transaction may be added using a tip selection protocol discussed below. An association of the original retractable transaction and a new non-retractable transaction related to retraction of the original transaction is stored in a distributed database and/or in the braid. In some implementations, transaction data of the new non-retractable transaction related to the retraction of the original retractable transaction may include ID of the original retractable transaction. Since transaction data may be stored in the braid, the original retractable transaction can be identified. Alternatively, one of distributed databases may store details of further transactions associated with the retractable transaction. In some implementations, the new non-retractable transaction may be for the same amount as the original retractable transaction. Alternatively, the non-retractable transaction may be for a different amount.

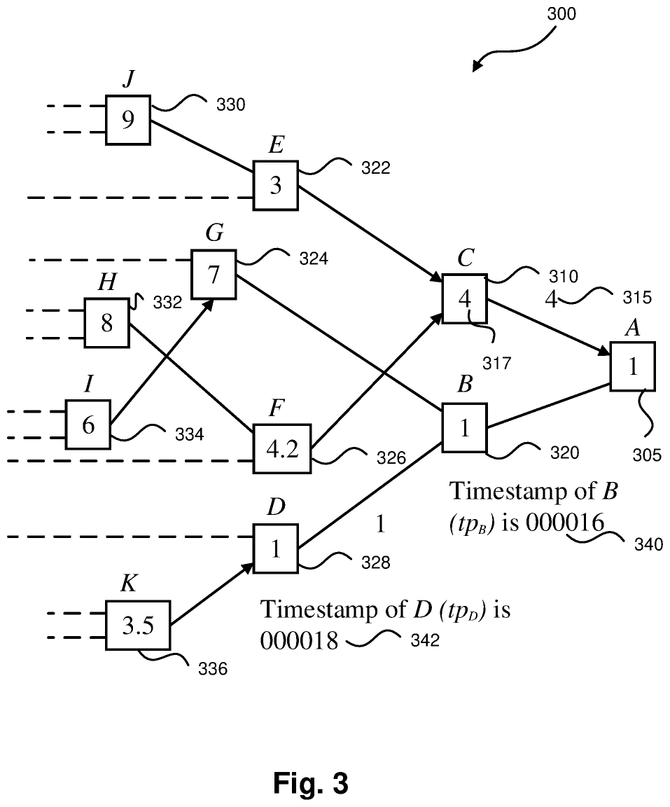

As discussed above, in the data structure, e.g., the braid 200, a non-retractable transaction may be associated with a non-retractable link, e.g. a directional link in this example, and a retractable transaction may be associated with a retractable link, e.g. a non-directional link in this example. Additionally, each transaction from the plurality of transactions may be associated with a transaction weight value, e.g., as shown in FIGS. 3-5. The transaction weight value may represent a total amount of work carried to process the respective transaction. Each link connecting two transactions may be associated with a link weight value, e.g., as shown in FIGS. 3-5. The link weight value can be based on the transaction weight value associated with at least one of the transactions connected by that link.

To add a transaction to the data structure, i.e., the braid 200, a tip from a plurality of tips may be selected. In some implementations, the tip may be determined based on Fuzzy Analytic Hierarchy Process (AHP). For example, the tip may be selected using the F-AHP based on preferences of the node requesting to add the transaction. The F-AHP is discussed in more details below with references to FIG. 13.

In some implementations, each request may involve mutual authentication which comprises generating a mutually authenticated key based on a key establishment protocol selected based on the type of the transaction. In other words, the node sending the request may select which key establishment protocol to use depending on the type of the transaction.

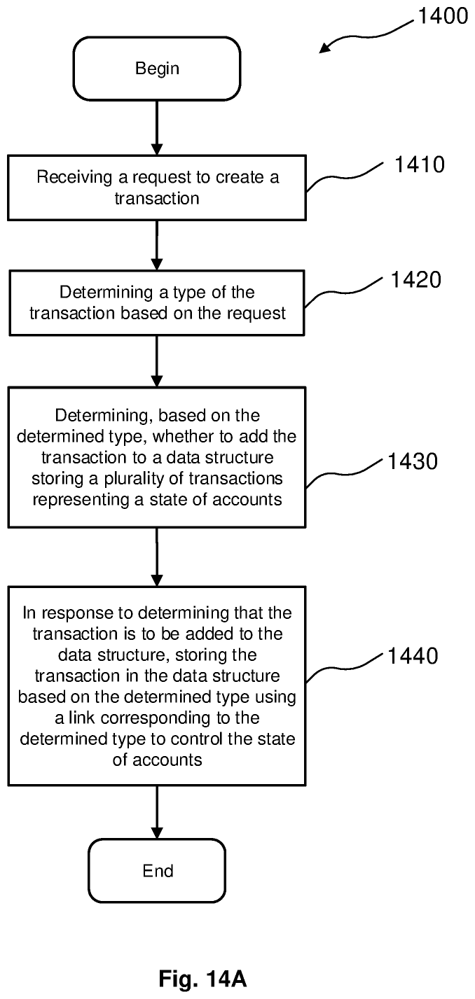

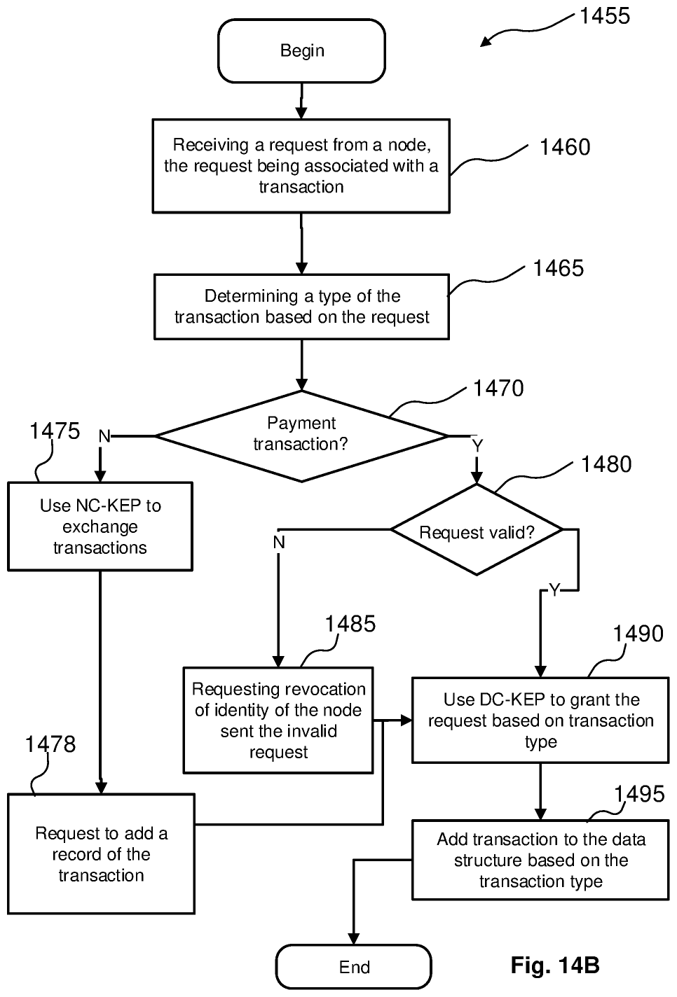

FIG. 14A shows a method 1400 of controlling a state of accounts in accordance with an alternative implementation of the present disclosure. Similar to the method 1100, the method 1400 uses a data structure, for example, an Acyclic Mixed Graph such as the braid 200, storing a plurality of transactions, for example, 210-235 and 250, representing the state of accounts. The plurality of transactions comprises payment-related transactions. The method 1400 may be executed on a processor 105 of a master distributed node 187 or a common IoT node 185 under control of instructions stored in memory 109.

The method 1400 commences at a step 1410 of receiving a request to create a transaction. The request may be received by a node, for example, an IoT node 185 associated with the device 192, of a plurality of nodes. The request may include a transaction type. In this implementation the transaction type may be at least one of pseudo (retractable) payment transaction, actual (non-retractable) payment transaction, identity creation transaction, identity revocation transaction, non-payment related transaction. In some implementations, the request also includes additional metadata for the transaction, such as transaction amount, transaction functionality, parties involved in the transaction and the like.

Step 1410 continues to a step 1420 of determining a type of the transaction based on the request. For example, the request can be parsed to extract the type of the transaction from the request. The type can be determined as a pseudo (retractable) payment transaction type, an actual (non-retractable) payment transaction type, an identity creation transaction, an identity revocation transaction type and a non-payment related transaction type.

The method 1400 proceeds from step 1420 to a step 1430 of determining, based on the determined type, whether to add the transaction to a data structure storing a plurality of transactions representing a state of accounts. If the type is other than the non-payment related transaction type, the transaction is added to the data structure, e.g. the braid 200. In some implementations, the transaction is added to the data structure using the Distributed Consensus-based Key Establishment protocol (DC-KEP). In other words, in response to determining that the transaction is to be added to the data structure, the method 1400 proceeds to a step 1440 storing the transaction in the data structure based on the determined type to control the state of accounts.

The transaction is stored in the data structure using a link corresponding to the determined transaction type. For example, the transaction is added to the data structure in association with the determined type, in the form of a corresponding link, to control the state of accounts. In some implementations, the transaction is added to the data structure using a Distributed Consensus-based Key Establishment protocol if the transaction is either a retractable payment transaction or a non-retractable transaction. The method 1400 may further comprise utilizing the transaction without being added to the data structure if the determined type is a non-payment functionality transaction, wherein the non-payment functionality transaction is utilised using a Non-Consensus-based Key Establishment protocol.

The retractable transaction is added to the data structure using a ‘retractable’ link, e.g. an undirected link, while a non-retractable transaction is added to the data structure using a ‘non-retractable’ link, e.g. a directed link. For the purposes of the present disclosure, the terms ‘retractable’ and ‘non-retractable’ are used merely to distinguish links for attaching retractable and non-retractable transactions. It is noted that the retractable links and non-retractable links are supposed to have different properties. In some implementations, a retractable link is non-directed while a non-retractable link is directed. In alternative implementations, retractable and non-retractable links may be distinguished based on tags or other metadata stored for the links.

If the transaction is a non-payment transaction, the transaction is not added to the data structure and confirmed by executing a Non-Consensus-based key establishment protocol between relevant parties to the non-payment transaction.

For example, if the request relates to adding a retractable payment transaction, the node issuing the transaction may execute the DC-KEP with one of the distributed master nodes to add a retractable tip to any available tips in the braid. If a transaction is not to be added to the data structure, the node can execute the Non-Consensus-based Key Establishment protocol (NC-KEP) with another node. If the request relates to adding a non-retractable transaction, the node issuing the transaction may execute the DC-KEP with one of the distributed master nodes which grants a tips pointer and a verifier for the non-retractable transaction in response to successful mutual authentication.

The method 1400 concludes on completion of step 1440.

FIG. 12 shows a method 1200 of processing a request from a node in accordance with one implementation of the present disclosure. The method 1200 may be executed on a processor 105 of a node 187 or 185 under control of instructions stored in memory 109.

The method 1200 commences at a step 1210 of receiving a request by the node, the request being associated with a transaction. For example, the request may be a request to add new transaction to the braid 200, to retract a transaction from the braid 200, a request to convert a retractable transaction to a non-retractable transaction, a request to revoke an identity or any other request. As discussed above, in some implementations, only a node which created a retractable transaction may request retraction of that transaction and/or conversion of the retractable transaction to a non-retractable transaction.

Step 1210 proceeds to a step 1220 of determining a type of the transaction based on the request. As discussed above, in some implementations, the type of the transaction can be extracted from the request. Alternatively, the type of the transaction can be determined from transaction data by identifying the transaction, if transaction already exists in the braid.

The method 1200 continues from step 1220 to a step 1230 of verifying the request based on the type of the transaction. Verification of the request may involve identifying a transaction in the data structure based on the request.

For example, as discussed below, for the request relating to adding a retractable new transaction, the method 1200 may check that the transaction does not already exist in the distributed databases 189 and the transaction has not been retracted. Additionally, the method 1200 may also determine whether the request is valid. For example, if the request relates to retracting a non-retractable transaction or retractable transaction which was previously retracted, the method 1200 may deem that the request is invalid. The method 1200 may further provide feedback to indicate to the node that the request cannot be performed since the transaction is non-retractable. The feedback may be in a form of a warning. Alternatively, if the node sends invalid requests more than a threshold number of times, the feedback may be in a form of revoking identity of the node. For requests to add a non-retractable transactions, the method 1200 may only check the transaction does not already exist in the distributed databases 189.

In response to positive verification at step 1230, the method 1200 continues from step 1230 to a step 1240 of performing mutual authentication. Mutual authentication can be implemented using key establishment protocols known in the art. Key establishment protocols not only enable mutual authentication, but also enable generation of a mutually authenticated key.

Upon successful mutual authentication in step 1240, the method 1200 proceeds to a step 1250 of granting the request based on the transaction type using the generated mutual authentication key.

In response to granting the request, the node proceeds to adding the transaction to the data structure, for example, using a tip selection protocol discussed with reference to FIG. 13. For example, if the request was to add a new transaction to the braid, a new retractable or a non-retractable transaction is added to the braid depending on the type of the requested transaction. If the request was to convert a retractable transaction to a non-retractable transaction, a new non-retractable transaction associated with the retractable transaction identified in the request is added to the data structure. Conversely, if the request was to retract a retractable transaction, a new non-retractable transaction associated with the retractable transaction identified in the request is added to the data structure.

The method 1200 concludes on completion of step 1250.

Other concepts of braid architecture are described below in more detail with references to notations indicated in Table 1.

TABLE 1
Notations adopted in the present disclosure

| Notation | Description | Notation | Description |
|---|---|---|---|
| aw | Attachment weight | is | Ephemeral secret key/Isogeny |
| w | Transaction weight | Ei, Ei₂, Ei₃, | Isogenous curves |
| | | Ei_{3, 2}, Ei_{2, 3} | |
| ID | Identity | po | Computed points |
| Hash(.) | Secure Hash | j(E₃, ₂), j(E₂, ₃) | j-variant |
| | Algorithm-256 (SHA- | | |
| | 256) | | |
| p | Prime modulus of an | kₛᵢ | SIDH key |
| | elliptic curve EC | | |
| a and b | Curve parameters of EC | kₘₛ | M-SIDH key |
| G | Generator point of EC | Enc(.) | Encryption part of an |
| | | | Advanced Encryption |
| | | | Standard (AES) |
| ni | Order of G | Dec(.) | Decryption part of an AES |
| h | Co-factor | MAC(.) | Message Authentication Code |
| | | | (MAC) signature |
| Ei/Fₚ_{²} | Supersingular elliptic | VMAC(.) | MAC verification |
| | curve | | |
| pm | Prime modulus for | ptr | Tips pointer |
| | SIDH | | |
| P₁, Q₁, P₂, Q₂ | Elliptic points for SIDH | v | Verifier |
| o₁^{e}^{₁} | Order of P₁, Q₁ for | t | Time |
| | SIDH | | |
| o₂^{e}^{₂} | Order of P₂, Q₂ for | AT | Available Tips |
| | SIDH | | |
| si | Secret integer | XMSS_{Sign}(.) | XMSS signature algorithm |
| rv | Ephemeral random | XMSS_{Verify}(.) | XMSS signature verification |
| | value | | algorithm |
| q | Large randomly | tp | Timestamp |
| | selected integer | | |
| pk | Ephemeral Private key | \tilde{X}^{k} | Pairwise contribution matrix |
| pbk | Ephemeral Public key | ãᵢⱼ^{k} | Decision-maker's k^{th} |
| | | | preference |
| xpk | XMSS private key | \tilde{g}ᵢ | Geometric mean of fuzzy |
| | | | comparison values |
| xpbk | XMSS public key | [symbol] | Reverse vector of \tilde{g}ᵢ |
| kₐ | ECDH key | \tilde{w}ᵢ | Fuzzy weight |
| kₘ | M-ECDH key | mwᵢ | Non-fuzzy weight |
| k_{S} | Shared secret session | nwᵢ | Normalized weight |
| | key | | |
| F′(.), F″(.), | Pseudo-Random | AD | Attachment identifier |
| F′″(.), F^{iv}, F^{v} | Functions (PRFs) | | |
| kₐ, kₐ₂ | Assurance keys | AData | Attachment data |
| M and M′ | Messages | TData | Transaction data |
| R_{Y} | Base point for SIDH | | |

FIG. 3 shows a braid 300 in accordance with an alternative implementation of the present disclosure. The braid 300 incorporates concepts of weights for transactions and for attachments or links between the transactions in the braid 300. The braid 300 shows transactions, e.g. A-K, and attachment weights assignments, e.g. 315. Similar to FIG. 2, boxes 305, 310, 320, 322-336 represent transactions. The number, e.g. 317, in each box represents a weight value of a corresponding transaction, and the number between two transactions, e.g. 315, represents an attachment weight value.

In some implementations, a transaction weight corresponds to the total amount of work carried out on the transaction by an IoT node. The amount of work refers to the activities associated with the transaction or the amount of processing, such as encrypting data, applying hash functions etc. For example, if no encryption is required a transaction way be assigned a weigh value of 1, otherwise a transaction may be assigned a weight value of 3. An attachment weight is a weight value of interconnection between two transactions. The attachment weight can be determined based on weight values of transactions connected by that attachment. For example, the attachment weight awCA 315 between the two transactions C 310 and A 305, is given as

$$awCA = wC / wA , \qquad ( 1 )$$

where awCA is the attachment weight of transaction C to transaction A, wC is the weight of transaction C, and wA is weight of transaction A in the braid 300.

If two linked transactions have the same transaction weight, a corresponding attachment weight of a link between these two transactions can be determined based on a weight of a later of the two linked transactions. The later transaction can be determined based on a timestamp associated with each transaction, e.g. timestamps 340 and 342. For example, if, in the case of pseudo transactions D 328 and B 320 without a direction, weights of transactions B 320 and D 328 are equal, i.e. wD=wB, an attachment weight awDB can be distinguished or determined using the transaction with the latest timestamp, e.g. 342, in the braid 300. In this example, the attachment weight awDB can be determined as the attachment weight of D, i.e., attachment weight from D to B as shown in FIG. 3. The transaction weights, attachment weights and timestamps can be stored in the braid 300 and/or in the distributed database 189.

The genesis transaction A 305 or root is the only transaction without an attachment weight since there is no interconnection from it to any other transaction.

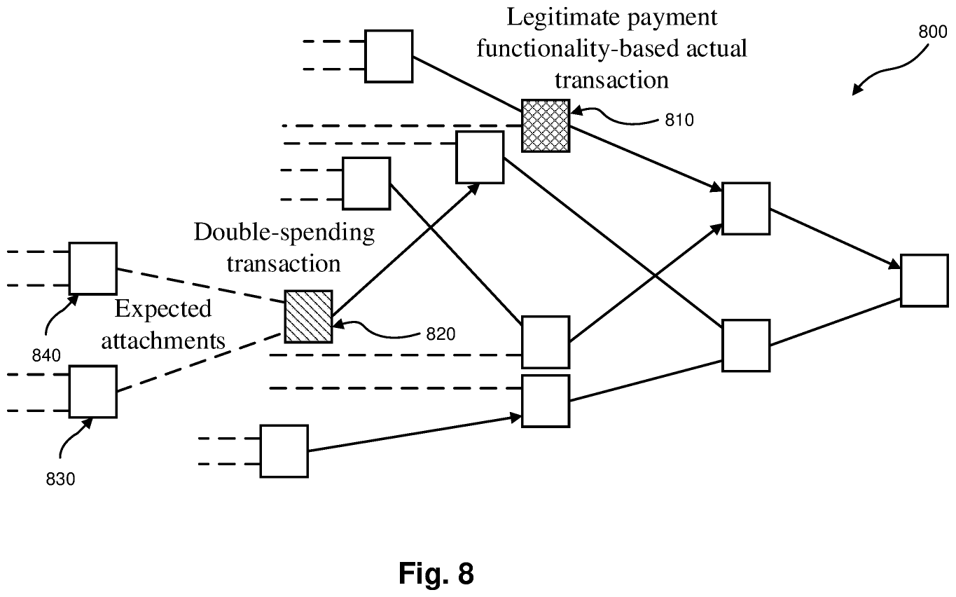

The attachment weights are particularly advantageous for mitigating splitting attacks and other related attacks against the braid 300 as discussed below with references to FIGS. 8-10. For example, in a splitting attack, an attacker attempts to split a distributed ledger into two branches to carry out double-spending in the branches. Thus, the attachment weight is calculated and used as an attribute and authentication factor in the braid 300 to avoid such attacks as discussed below. To connect two transactions together, the attachment weight between the transactions is calculated by dividing the total weight (or size) of the preceding transaction with the total weight (or size) of the succeeding transaction. The value of the attachment weight is now added to the attachment tag of the succeeding transaction to mitigate the above attack.

### Key Establishment Module

The key establishment module is configured to implement a plurality of key establishment protocols used for exchanging transactions and reaching consensus on the transactions in the Cryptiot. The key establishment module may implement quantum-resistant cryptographic methods such as a Supersingular Isogeny Diffie-Hellman key exchange method (SIDH) and an extended Merkle Signature Scheme (XMSS) method to provide resistance against quantum computers.

The key establishment module identifies an IoT node by an identity ID derived from a node name and attributes of the IoT node. In some implementations, the identity of the IoT node (ID) can be issued by a distributed master node, i.e. any distributed master node. For example, the distributed master node can assign the identity ID determined as ID=Hash(φ), where φ represents the name and unique attributes of the IoT node and Hash(⋅) is a Secure Hash Algorithm-256 (SHA-256).

In some implementations, the distributed master node may store the identity ID on the braid, for example in transaction data, and in the distributed database. The distributed master node is configured to synchronise the distributed database of the distributed master node with distributed databases of the other distributed master nodes in the Cryptiot network. The distributed databases are configured to be available for data storage and verification, i.e. the distributed databases are trusted for availability and correctness.

The identity ID of any IoT node can be revoked (as ID(revoked)) by a distributed master node if the IoT node violates the actual and pseudo transactions rule and/or misuses any cryptographic algorithms associated with any transaction or command (discussed below). For example, the identity ID of an IoT node can be revoked if the IoT node attempts to retract an actual transaction. The revoked identity ID(revoked) is stored on the braid and distributed database for verification purposes. For example, the revoked identity can be stored on the braid as a tip using the DC-KEP. In some arrangements, transactions related to identities of IoT node are considered to be payment related transactions as such identities may be ultimately involved in payments.

In some implementations, a genesis distributed master node owned by the first founder of the braid enrolls and issues an identity to the first distributed master node and provides system bootstrapping that initialises the protocol suite and all rules in Cryptiot. The identity of an IoT node can be issued by any distributed master node since all the distributed master nodes maintain identical information on their distributed databases. The distributed master nodes do not store sensitive information such as secret values of other IoT nodes and shared secret keys.

For adding new transactions and verifying existing transactions, the IoT nodes have permissions to use the key establishment module for performing the following cryptographic operations:
generating ephemeral random value, ephemeral public keys, and ephemeral private keys for supporting node authentication (note that an ephemeral value lasts for a very short time);
computing shared secret keys for supporting mutual authentication and securing transactions;
performing implicit key confirmation to ensure that an IoT node can compute a shared secret key and explicit key confirmation to ensure that the IoT node holds the shared secret key; and
requesting, granting, extracting, and verifying of a tips pointer and a verifier for a transaction.

In addition to the above operations, the distributed master nodes have permissions to use the key establishment module granting the tips pointer and verifier. The key establishment module is configured to guarantee that only the genuine owners of shared secret keys can use the keys for related cryptographic operations.

The key establishment module can be based on different cryptographic schemes, such as an Elliptic Curve Diffie-Helman (ECDH) key exchange algorithm, a Supersingular Isogeny Diffie-Hellman (SIDH) key exchange algorithm, and an extended Merkle Signature Scheme (XMSS). Each of cryptographic schemes adopted by the key establishment module can be specifically configured to provide mutual authentication and key confirmation. Use of mutual authentication and key confirmation assist in preventing replay attacks, active man-in-the-middle attacks, and other related attacks. The key establishment module can be parametrised depending on the chosen cryptographic scheme.

For example, in some implementations, a mutually authenticated ECDH (M-ECDH) key exchange protocol is used. The M-ECDH protocol provides mutual authentication and key confirmation in addition to establishment of a shared secret key as per the conventional ECDH key exchange protocol. In cases where the M-ECDH protocol is used, the key establishment module can be parametrised using the elliptic curve domain parameters (p, a, b, G, ni, h), where p is a prime modulus, a and b are curve parameters, G is a generator point, ni is an order of G in an elliptic curve EC over a finite field Fq, and h is a cofactor.

In other implementations, a mutually authenticated SIDH (M-SIDH) can be used as an alternative to the M-ECDH to enhance protection against attacks originating from quantum computers. The M-SIDH is similar to the SIDH and additionally provides mutual authentication and key confirmation. In cases where the -SIDH protocol is used, the key establishment module can be parametrised using supersingular elliptic curve public parameters (Ei/F_{P}², pm, P₁, Q₁, P₂, Q₂), where Ei/F_{P}² is a supersingular elliptic curve, pm is a prime modulus for SIDH, P₁ and Q₁ are two elliptic points that generate an order o₁^{e1} for SIDH, and P₂ and Q₂ are additional two elliptic points that generate an order o₂^{e2} for SIDH.

The key establishment module may additionally use the XMSS with Winternitz One-Time Signature Plus (WOTS+) to provide cryptographic digital signature. The XMSS is a quantum-resistant hash-based digital signature system that is supported by an XMSS private key for signing a message and an XMSS public key for verifying the signed message. The XMSS private key may comprise WOTS+ private keys. In cases where the -SIDH protocol is used, the key establishment module can be parametrised using XMSS parameters (nx, wx, mx, H), where nx is a security parameter, wx a Winternitz parameter, mx is a message length in bits and H is a tree height (where XMSS makes 2^{H} signatures using one keypair).

In addition to the ECDH, SIDH, and EMSS, the key establishment module may implement and use existing cryptographic algorithms such as Pseudo-Random Functions (PRFs) and Advanced Encryption Standard (AES). Furthermore, the key establishment module uses a tuple of identities, ephemeral random values and public values for authentication of nodes. The tuple associates the ephemeral random values and public keys to node identities thereby ensuring that the ephemeral random values and the public keys do not already belong to any other nodes and do not exist in any of the distributed databases of the distributed master nodes.

The key establishment module enforces properties of a well-behaved environment. Properties of a well-behaved environment can be stated as follows: an unknown value cannot be used in a run of a protocol within the protocol suite and all the cryptographic schemes algorithms used by the protocol fulfil their expected assumptions. For example, an encryption algorithm that takes a plaintext will yield a ciphertext of the plaintext. In other words, if an IoT node is executing a command within the key establishment module using unverified data, the key establishment module can stop and halt the execution of the command at any point in response to the key establishment module determining that any property of the well-behaved environment is violated. By stopping and halting execution in response to determining that a property of the well-behaved environment is violated, the key establishment module enforces the natural execution of the protocol. For example, if a wrong secret key is applied to decrypt an encrypted message, the protocol stops thereby showing that the property of decryption is violated. Different key establishment protocols fulfilling the well-behaved environment properties may be used.

The general commands that the protocol suite provides to nodes are listed below. The commands can be executed on a processor 105 of each node under control of instructions stored in memory 109 of the node.

### Verify an Identity (VerifyID)

In response to receiving a command to verify an identity a another IoT node, e.g. identity ID_{Z}, an IoT node ID_{Y} verifies whether another IoT node's identity ID_{Z} exists and the IoT node's revocable identity ID_{Z} (revoked) does not exist in the braid and any of the distributed databases.

### Get Elliptic Curve Domain Parameters (GetECDP)

In response to receiving a command to get elliptic curve domain parameters, the IoT node ID_{Y} gets the elliptic curve domain parameters (p, a, b, G, ni, h) available in the braid.

### Generate a New Ephemeral Random Value (GenRV)

In response to receiving a command to generate a new ephemeral random value, the IoT node ID_{Y} generate a new ephemeral random value rv_{Y}ϵ{1, . . . , q−1}, where q is a large randomly selected integer in the braid.

### Generate a New Ephemeral Private Key (GenPK)

To generate a new ephemeral private key, the IoT node ID_{Y} generates an ephemeral private key pk_{Y}ϵ{1, . . . , ni−1}, computes a corresponding ephemeral public key pbk_{Y}=pk_{Y}·G, and then adds (ID_{Y}, rv_{Y}, pbk_{Y}) to any of the distributed databases. Note that since (ID_{Y}, rv_{Y}, pbk_{Y}) can be made publicly available, the generated values of the IoT node identification ID_{Y}, ephemeral random value rv_{Y} and the ephemeral public key pbk_{Y} can be stored directly in the distributed databases, for example, in memory 109 of the computer system 100.

### Verify Public Values (VerifyVals)

Upon receiving an ephemeral random value rv_{Z}, an ephemeral public key pbk_{Z}, and an identity ID_{Z}, the IoT node ID_{Y} verifies whether (ID_{Z}, rv_{Z}, pbk_{Z}) exists in any of the distributed databases. If (ID_{Z}, rv_{Z}, pbk_{Z}) exists in any of the distributed databases, the IoT node ID_{Y} confirms the identity ID_{Z} of another IoT node. The IoT node ID_{Z} may follow a similar process to verify or confirm the identity of the IoT node ID_{Y}. Verification of public values of the IoT nodes ID_{Z} and ID_{Y} by looking up (ID_{Z}, rv_{Z}, pbk_{Z}) in the distributed databases provides mutual authentication.

### Compute an M-ECDH Key (CompMKey)

The IoT node ID_{Y} computes an M-ECDH key kₘ from the ephemeral private key pk_{Y} of the IoT node ID_{Y} and random value rv_{Y} generated by the IoT node ID_{Y}, the ephemeral random value rv_{Z} generated by the IoT node ID_{Z} and public key pbk_{Z} of the key establishment partner IoT node ID_{Z}. If (ID_{Z}, rv_{Z}, pbk_{Z}) is available in any of the distributed databases, the IoT node ID_{Y} computes an ECDH key kₑ=pk_{Y}·pbk_{Z} and then compute an M-ECDH key kₘ=F′(Hash(kₑ·rv_{Y}·rv_{Z})) to provide M-ECDH key secrecy. where F′(⋅) is a Pseudo-Random Function (PRF) for deriving an M-ECDH key. Note that the use of Hash(⋅) and F′(⋅) enhances the secrecy of kₑ. Note that the successful execution of VerifyID, GetECDP, GenRV, GenPK, VerifyVals, and CompMKey commands by the IoT nodes ID_{Y} and/D_{Z} represent the mutual authentication of the key establishment protocol M-ECDH.

### Implicit Key Confirmation (KeyIConfirm)

The IoT node ID_{Y} is assured that ID_{Z} can compute the M-ECDH key kₘ by computing some messages: M₁=Encₖ_{ₘ}(pk_{Y}, pbk_{Z}, rv_{Y}, rv_{Z}), M₂=MACₖ_{ₘ}(M₁), an assurance key kₐ=F″(Hash(kₘ,M₂)), and additional messages M3=Encₖ_{ₐ}(rv_{Y}, rv_{Z}) and M₄=MACₖ_{ₐ}(M₃), where Enc(⋅) is the encryption part of the AES, MAC(⋅) is a Message Authentication Code (MAC), and F″(⋅) is another PRF for deriving an assurance key kₐ. Note that kₐ provides additional authentication and enhances assurances during key establishment.

For example, the message M₁=Encₖ_{ₘ}(pk_{Y}, pbk_{Z}, rv_{Y}, rv_{Z}) is computed by encrypting the private key of ID_{Y}, public key of ID_{Z} and the ephemeral random values rv_{Y}, rv_{Z} using the mutually authenticated key M-ECDH key kₘ. The message M₂=MAC_{K}_{ₘ}(M₁) is computed as a message authentication code (or signature) of M₁ using the mutually authenticated key M-ECDH key kₘ. The assurance key kₐ=F″(Hash(kₘ,M₂)) is computed using a pseudo-random function of a hash value of the mutually authenticated key M-ECDH key kₘ and M₂. The message M₃=Encₖ_{ₐ}(rv_{Y}, rv_{Z}) is computed by encrypting the ephemeral random values rv_{Y}, rv_{Z} using the assurance key and the message M₄=MACₖ_{ₐ}(M₃) is computed as a message authentication code (or signature) of M₃ using the assurance key.

### Explicit Key Confirmation (KeyEConfirm)

Upon receiving M₁′, M₂′, M₃′, and M₄′ from the IoT node ID_{Z}, where M₁=M₁′, M₂=M₂′, M₃=M₃′, and M₄=M₄′ without loss of generality, the IoT node ID_{Y} can be assured that ID_{Z} holds the M-ECDH key kₘ by computing VMACₖ_{ₘ}(M₂′)=M₁′, Decₖ_{ₘ}(M₁′)=pk_{Y}, pbk_{Z}, rv_{Y}, rv_{Z}, kₐ=F″(Hash(kₘ,M₂′)), VMACₖ_{ₘ}(M₄′)=M₃′, and Decₖ_{ₐ}(M₃′)=rv_{Y}, rv_{Z}, where VMAC(⋅) is the MAC verification of MAC(⋅) and Dec(⋅) is the decryption part of Enc(⋅).

### Compute Shared Secret Session Key (CompSKey)

In response to receiving a command to compute a shared secret session key, the IoT node ID_{Y} computes a shared secret session key k_{S} from an M-ECDH key kₘ, an assurance key kₐ, and ephemeral random values rv_{Y} and rv_{Z}. For example, the shared secret session key can be computed as k_{S}=F′″(Hash(kₘ, kₐ, rv_{Y}, rv_{Z})) to support shared secret session key secrecy, where F′″ is a PRF for deriving a shared secret session key k_{S}. Thus, k_{S} is shared between the IoT nodes ID_{Y} and ID_{Z} and can be used by ID_{Y} and ID_{Z} to encrypt and process a transaction between each other.

### Shared Secret Session Key Usage for Securely Establishing a Pseudo Transaction (S_SKeyusage)

The IoT node ID_{Y} uses the shared secret key k_{S} to establish a pseudo transaction L to its key establishment partner ID_{Z} by encrypting the pseudo transaction L using the shared secret session key k_{S}. For example, the IoT node ID_{Y} can encrypt the pseudo transaction L concatenated with a hash value of the pseudo transaction L using the shared secret session key k_{S} to generate a message M_{1.L}=Encₖ_{_{S}}(Hash(L),L) and compute a message authentication code (signature) M_{2.L}=MAC(M_{1.L}) of the message M_{1.L}.

### Shared Secret Session Key Usage for Securely Obtaining a Pseudo Transaction (O_SKeyusage)

Upon receiving M_{1.L}′ and M_{2.L}′ from ID_{Z}, where M_{1.L}′=M_{1.L} and M_{2.L}′=M_{2.L} without loss of generality, the IoT node ID_{Y} obtains the transaction by computing VMACₖ_{_{S}}(M_{2.L})=M_{1.L} and Decₖ_{_{S}}(M_{1.L})=(Hash(L),L). The pseudo transaction can then be verified by successfully computing Hash(L),L. For example, computation of Decₖ_{_{S}}(M_{1.L}) is considered to be successful if the result of the computation satisfies the format Hash (L), L. The result of computation Decₖ_{_{S}}(M_{1.L}) is used to extract transaction L, for example, for discarding first bits which are expect to correspond to the hash value typically known in advance, e.g. 256 bits for SHA256.

### Request a Tips Pointer and a Verifier for a New Actual Transaction (ReqEPM)

To request a tips pointer and a verifier for a new actual transaction N using the M-ECDH key kₘ, the IoT node ID_{Y} computes messages M_{1.N}=Encₖ_{ₘ}(Hash(N),N) and M_{2.N}=MACₖ_{ₘ}(M_{1.N}). The messages M_{1.N}=Encₖ_{ₘ}(Hash(N),N) and M_{2.N}=MACₖ_{ₘ}(M_{1.N}) are sent to a distributed master node.

### Grant a Tips Pointer and a Verifier for a New Actual Transaction (GrantEPM)

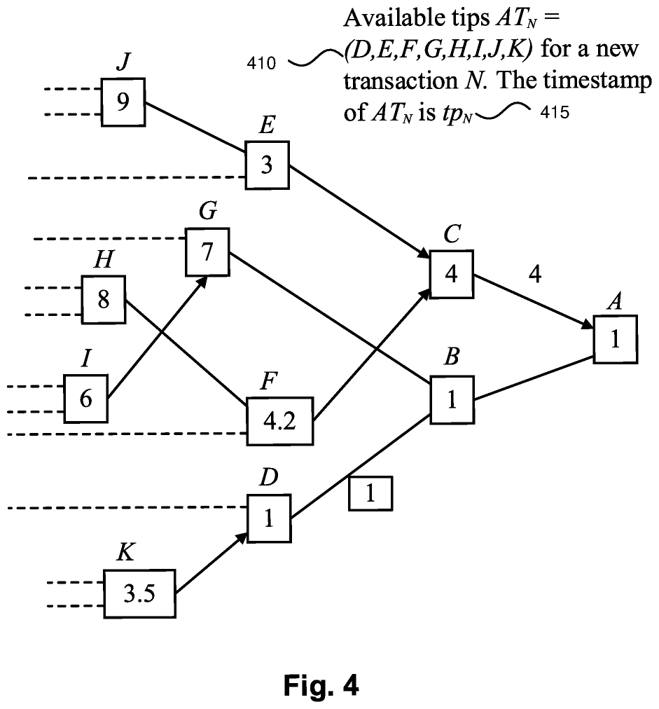

In some implementations, the grant a tip pointer and a verifier command is only available to the distributed master nodes. The grant a tip pointer and a verifier command is typically executed in response to receiving the messages M_{1.N} and M_{2.N} from an IoT node. To grant a tips pointer and a verifier for a new actual transaction N, a distributed master node ID_{DS1} verifies a Message Authentication Code (MAC) signature for M_{2.N} using the M-ECDH key kₘ VMACₖ_{ₘ}(M_{2.N})=M_{1.N}, decrypts M_{1.N} using M-ECDH key kₘ Decₖ_{ₘ}(M_{1.N})=(Hash(N),N), and verifies whether Hash(N) and (Hash(N),N) exist in the braid as follows. If Decₖ_{ₘ}(M_{1.N}) is computed at time t_{N.2}, the distributed master node ID_{DS1} verifies whether Hash(N) and (Hash(N),N) exist in the braid at the time t_{N.1}+t_{N.2}, where t_{N.1} is the time the distributed master node ID_{DS1} observes the state of the braid when it receives M_{1.N} and M_{2.N}. If all the verifications fail, the distributed master node ID_{DS1} proceeds to verify the transaction type before granting the tips pointer and verifier as follows.
a. If N is a pseudo transaction, the distributed master node ID_{DS1} computes Hash(N, Retract) and verifies whether Hash(N, Retract) exists in the braid and in M_{1.N}. Otherwise, if N is an actual transaction, the distributed master node ID_{DS1} also computes Hash(N, Retract) and verifies whether Hash(N, Retract) does not exists in the braid and in M_{1.N}. If any of verifications succeeds, the distributed master node determines that ID_{Y} violates N and misuses ReqEPM command and then the distributed master node ID_{DS1} proceeds to revoke the identity of the ID_{Y} node.
b. If all of the verifications fail, the distributed master node ID_{DS1} proceeds to grant the tips pointer and verifier as follows. The distributed master node ID_{DS1} looks up the braid and generates a plurality of available tips on braid, for example in a form of a list as shown in FIG. 4 AT_{N}=(D, E, F, G, H, I, J, K). FIG. 4 shows the list of available tips AT_{N} 410 and a timestamp tp_{N} 415 of the list of available tips 410. The distributed master node ID_{DS1} continues to set a pointer ptr_{N} to (AT_{N}, tp_{N}, info, Hash(N),N), i.e., ptr_{N}=(AT_{N}, tp_{N}, info, Hash(N),N), stores (AT_{N}, tp_{N}, info, Hash(N),N) in a distributed database associated with the distributed master node ID_{DS1}, where tp_{N} is a timestamp indicating the time AT_{N} was generated and info is any additional information or artifacts. The distributed master node also computes a message M_{3.N}=Encₖ_{ₘ}(ptr_{N}) by encrypting the generated pointer using the M-ECDH key kₘ and a message authentication code or signature M_{4.N}=MACₖ_{ₘ}(M_{3.N}) of the computed message. The distributed master node ID_{DS1} may also get the eXtended Merkle Signature Scheme (XMSS) parameters (nₓ,wₓ,mₓ,H), create XMSS private key xpk_{DS1} and XMSS public key xpbk_{DS1}, and compute a verifier

$${v}_{N} = {XMSS}_{{Sign}_{{xpk}_{DS 1}}} ( Hash ( {M}_{4. N} ) )$$

to grant the tips pointer and verifier for N, where XMSS_{Sign}(⋅) is the XMSS signature algorithm.

### Request for a Pseudo Transaction Retraction (ReqTRR)

An IoT node ID_{Y} may request retraction of a pseudo transaction. Retraction of the pseudo transaction can be requested by a node which created that pseudo transaction or otherwise participated in the pseudo transaction. To retract the pseudo transaction, the IoT node ID_{Y} may use an M-ECDH key kₘ shared with a distributed master node ID_{DS2}. The IoT node ID_{Y} computes two messages M_{1.B} and M_{2.B} to request the distributed master node ID_{DS2} to retract a pseudo transaction B. A first message M_{1.B} is generated by encrypting a hash value of transaction data of the transaction B to be retracted concatenated with the transaction data of the transaction B and a hash value of the transaction B and a command to retract the transaction B as M_{1.B}=Encₖ_{ₘ}(Hash(B),B,Hash(B,Retract)). A second message M_{2.B}=MACₖ_{ₘ}(M_{1.B})) is generated as a message authentication code (or signature) of the first message M_{1.B} using the M-ECDH key kₘ. The messages are sent to a distributed master node.

### Grant a Tips Pointer and a Verifier for a Pseudo Transaction Retraction (GrantEPM_TRR)

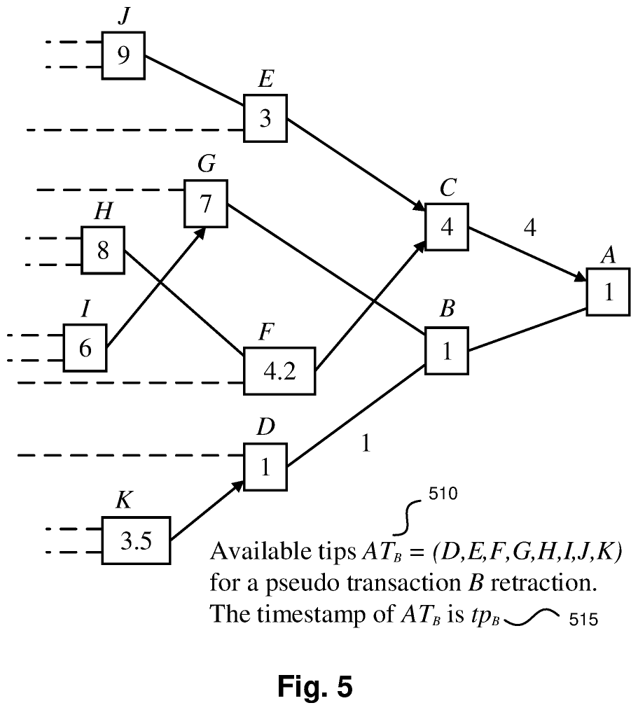

In some implementations, only the distributed master nodes are able to grant a tips pointer and a verifier for a pseudo transaction retraction. Upon receiving messages M_{1.B} and M_{2.B} to retract a pseudo transaction via ReqTRR from the IoT node ID_{Y}, the distributed master node ID_{DS2} verifies the received messages by computing VMACₖ_{ₘ}(M_{2.B})=M_{1.B} and Decₖ_{ₘ}(M_{1.B})=(Hash(B),B,Hash(B,Retract)). The distributed master node ID_{DS2} verifies the request, i.e., determines that the retraction request is valid, if VMACₖ_{ₘ}(M_{2.B}) equals Decₖ_{ₘ}(M_{1.B}). Additionally, if the retraction request is valid, the distributed master node ID_{DS2} verifies whether the IoT node ID_{Y} requesting the retraction is the owner of the transaction B being retracted. The ownership of the transaction B is determined by checking that the IoT node identifier ID_{Y} is specified in the transaction data as the sender of the transaction B to be retracted. The distributed master node ID_{DS2} also determines that values Hash(B), (Hash(B),B), and Hash(B, Retract) exist in the braid. To determine that the values Hash(B), (Hash(B), B), and Hash(B, Retract) exist in the braid, the distributed master node ID_{DS2} verifies whether Hash(B), (Hash(B), B), and Hash(B, Retract) exist in the braid at t_{B.1}+t_{B.2} If Decₖ_{ₘ}(M_{1.B}) is computed at time t_{B.2}, where t_{B.1} is the time ID_{DS2} observes the state of the braid when it receives M_{1.B} and M_{2.B}. If all the verifications fail, the transaction was not previously retracted, the distributed master node ID_{DS2} proceeds to verify a transaction type before granting the tips pointer and verifier as follows. It should be noted that any distributed master node can be used to request for a pseudo transaction retraction and to grant a tips pointer and a verifier for a pseudo transaction retraction. ID_{DS2} is used for consistency only.
a. If the transaction B to be retracted is an actual transaction, the existence of Hash(B, Retract) in M_{1.B} indicates that the IoT node ID_{Y} violates the transaction B and misuses the retraction command ReqTRR. Accordingly, if the distributed master node ID_{DS2} determine that the transaction B is an actual transaction and that a retraction command Hash(B, Retract) exists in the received message M_{1.B}, the distributed master node ID_{DS2} proceeds to revoke the credentials of the IoT node ID_{Y}.
b. If all the verifications fail, the distributed master node ID_{DS2} proceeds to grant the tips pointer and verifier as follows. Specifically, the distributed master node ID_{DS2} looks up the braid 200 or 300 and generates the available tips on braid (as shown in FIG. 5) AT_{B}=(D,E,F,G,H,I,J,K). Specifically, FIG. 5 shows the list of available tips AT_{B} 510 and a timestamp tp_{B} 515 for the list of available tips 510. Then, the distributed master node ID_{DS2} sets a pointer ptr_{B} to (AT_{B},tp_{B},info,Hash(B),B,Hash(B, Retract)), i.e., ptr_{B}=(AT_{B},tp_{B},info,Hash(B),B,Hash(B, Retract)). The distributed master node ID_{DS2} also stores ptr_{B} in a corresponding distributed database of the distributed master node ID_{DS2}, where tp_{B} is a timestamp indicating the time AT_{B} was generated and computes messages M_{3.B}=Encₖ_{ₘ}(ptr_{B}) and M_{4.B}=MACₖ_{ₘ}(M_{3.B}). The distributed master node ID_{DS2} also gets the extended Merkle Signature Scheme (XMSS) parameters (nₓ,wₓ,mₓ,H), creates a XMSS private key xpk_{DS2} for the distributed master node ID_{DS2} and XMSS public key xpbk_{DS2} for the distributed master node ID_{DS2}, and computes a verifier

$${v}_{N} = {XMSS}_{{Sign}_{{xpk}_{DS 2}}} ( Hash ( {M}_{4. B} ) )$$

of the computed messages to grant the tips pointer and verifier for B, where XMSS_{Sign}(⋅) is the XMSS signature algorithm.
c. It should be noted that:
   (I) The distributed master node ID_{DS2} can send M_{3.B}, M_{4.B}, v_{N}, and xpbk_{DS2} to the IoT node after executing GrantEPM_TRR.
   (II) In response to successful retraction of a retractable transaction, a new transaction is added to the braid after a retraction. The new transaction can be a new actual transaction corresponding to the retracted transaction. The new actual transaction can be added to the braid using KEPs and tip selection techniques of the present disclosure.

### Extract a Tips Pointer for a Transaction (ExtractEP)

To extract a tips pointer for a transaction (say, the actual transaction N), an IoT node receives encrypted messages M_{3.N} and M_{4.N} comprising the pointer. To extract the pointer from M_{3.N} and M_{4.N}, the IoT node ID_{Y} uses the M-ECDH key kₘ to compute VMACₖ_{ₘ}(M_{4.N})=M_{3.N} and Decₖ_{ₘ}(M_{3.N})=ptr_{N}=(AT_{N},tp_{N},info,Hash(N),N).

### Verifying Authenticity of a Verifier for a Transaction (VerifyV)

The IoT node ID_{Y} uses XMSS public key xpbk_{DS1} of another IoT node ID_{DS1} to verify the authenticity of a verifier for a transaction, for example, the actual transaction N, by computing

$${XMSS}_{{Verify}_{{xpbk}_{DS 1}}} ( Hash ( {M}_{4. N} ) ) ,$$

where XMSS_{Verify}(⋅) is the XMSS signature verification algorithm. If the verification is successful, the IoT node ID_{Y} confirms authenticity of the verifier v_{N} of the transaction N.

In some implementations, secret keys or values are not saved on the braid or any distributed databases. Shared secret keys are modelled to expire within a short time after usage. As such, shared secret keys from key establishment protocols are usually short-lived to mitigate any attack or compromise. Thus, IoT nodes (or simply nodes) can no longer use such keys in Cryptiot after intended usage to support perfect forward secrecy.

To grant request and grant a tips pointer and a verifier, extract the tips pointer, and confirm the verifier for a transaction, IoT nodes such as ID_{Y} are allowed to request the tips pointer and verifier, extract the tips pointer, and confirm the verifier. In some implementations, the distributed master nodes such as ID_{DS1} are the only nodes that can grant the tips pointer and verifier. Thus, the distributed master nodes can use all the commands in the protocol suite outlined above.

In some implementations, a node only requires one tip (with less than two other attached tips) to attach a new transaction. Transactions in any list of available tips AT are provided in a chronological order to support selection of old available tips and enhance the positive growth of the braid. In alternative implementations, the list of available tips AT may be generated based on a maximum number of new tips which can be attached to a tip in the list. For example, as shown in FIG. 3, only one new tip can be attached to transaction F 326 while two new tips can be attached to transaction H 332.

Security of the protocol suite is supported by security of the underlying cryptographic functions and algorithms. A single M-ECDH key is used to simplify description of the protocol suite. The protocol suite, however, may generate multiple M-ECDH keys using two or more groups in ECDH. Different M-ECDH keys may be computed to secure multiple transactions.

In Cryptiot, any node such as ID_{Y} can retract pseudo transaction issued by that node ID_{Y}. For example, the node ID_{Y} can retract pseudo transaction B (as shown above) by sending a pseudo transaction retraction request to the distributed master node, for example ID_{DS2}, using the ReqTRR command. As discussed above, the distributed master node ID_{DS2} uses GrantEPM_TRR command to grant a tips pointer and a verifier for the transaction B to be retracted.

In some implementations, the protocol suit provides general mutually authenticated Supersingular Isogeny Diffie-Hellman (M-SIDH) key exchange commands to every node are as follows.

### Get SIDH Public Parameters (GetSCPP)

The node ID_{Y} can execute a command GetSCPP to get the SIDH public parameters (Ei/F_{P}_{²}, p₁, P₁, Q₁, P₂, Q₂,) available in the braid or any of the distributed databases. For example, in the course of executing the command GetSCPP the node ID_{Y} may access the public parameters stored in the braid or query one of the distributed databases to provide the public parameters of SIDH.

### Generate a Base Point for SIDH (GenBPS)

In response to receiving instructions to generate a base point for SIDH, the node ID_{Y} generates a random base point R_{Y}=P₁+si_{Y}(Q₁) using a secret key si_{Y}<o₁^{e}^{₁} of the ID_{Y} where Q₁ is a fixed elliptic point on Ei.

### Compute a New Ephemeral Secret Key for SIDH (CompSKS)

In response to receiving instructions to compute a new ephemeral secret key for SIDH, the node ID_{Y} uses a random base point R_{Y} for an isogeny mapping to compute new pair of an ephemeral secret key and an ephemeral public key for the node ID_{Y}. The new pair of ephemeral keys is computed by determining an isogeny mapping is_{Y}:Ei→Ei₂ and an isogenous curve Ei₂ of Ei using the random base point. The isogeny mapping is used as the ephemeral secret key. The isogenous curve Ei₂ of Ei together with points is_{Y}(P₂) and is_{Y}(Q₂) is considered as the corresponding ephemeral public key. The node ID_{Y} adds (ID_{Y},rv_{Y2},is_{Y}(P₂),is_{Y}(Q₂)), which include new ephemeral public key of the node ID_{Y}, to any of the distributed databases, where rv_{Y2} is a new random value generated via GetRV command.

### Verify SIDH Public Values (VerifySVals)

In response to receiving instructions to verify the SIDH public values, the node ID_{Z} verifies whether (ID_{Y},rv_{Y2},is_{Y}(P₂),is_{Y}(Q₂)) of a node ID_{Y} exists in any of the distributed databases. Similar to the VerifyVals command, successful verification of the public values of ID_{Y} and ID_{Z} provides mutual authentication.

### Compute an M-SIDH Key (CompMSKey)

In response to receiving instructions to compute a mutual authentication key M-SIDH key, the node ID_{Y} determines if (ID_{Z},rv_{Z2},is_{Z}(P₁), is_{Z}(Q₁)) exists in any of the distributed databases. If the node determines that (ID_{Z},rv_{Z2},is_{Z}(P₁), is_{Z}(Q₁)) exists in any of the distributed databases, the node ID_{Y} uses own secret key si_{Y} of and the public key of the key exchange partner ID_{Z} to compute a point po_{ZY}=is_{Z}(P₁)+si_{Y}(is_{Z}(Q₁)).

The node ID_{Y} uses the point po_{ZY} to compute a second isogeny is_{ZY}:Ei₃→Ei_{3,2}. As Ei_{3,2} and Ei_{2,3} are isomorphic, where po_{YZ}=is_{Y}(P₂)+si_{Z}(is_{Y}(Q₂)) and an isogeny is_{YZ}:Ei₂→Ei_{2,3} via po_{YZ}, Ei_{2,3} and Ei_{3,2} have the same j-variant, i.e., j(Ei_{3,2})=j(Ei_{2,3}). Thus, the j variant can be used as a shared secret key kₛᵢ or SIDH key, i.e., j=kₛᵢ. The node ID_{Y} computes a mutually authenticated M-SIDH key kₘₛ using a pseudo-random function (PRF) F′^{v}(⋅) based on the shared secret key kₛᵢ as kₘₛ=F′^{v}(Hash(kₛᵢ)). Note that the use of Hash(⋅) and F′^{v}(⋅) enhances the secrecy of the mutually authenticated key kₘₛ. In some implementations, however, there is no need to apply a pseudo-random function and a hash function to the shared secret key and the shared secret key may be used directly as the mutually authenticated M-SIDH key kₘₛ. The successful execution of VerifyID, GetSCPP, GenRV, GenBPS, CompSKS, VerifySVals, and CompMSKey commands by ID_{Y} and ID_{Z} represent the mutually authenticated Supersingular Isogeny Diffie-Hellman (M-SIDH) key exchange protocol (M-SIDH).

An example sequence of steps of the M-SIDH protocol is provided in Table 2 below.

TABLE 2
Sequence of steps performed by two IoT nodes for mutually authentication using M-SIDH key exchange protocol

| ID_{Y} | | ID_{Z} |
|---|---|---|
| 1. VerifyID: Check that ID_{Z} exists and ID_{Z} (revoked) does not exists in the braid and any of the distributed | | |
| databases | | |
| 2. GetSCPP: (Ei/ | | |
| Fₚ₂, p₁, P_{Y}, Q_{Y}, P_{Z}, Q_{Z},) 3. GetRVrv_{Y2} ∈ {1, . . ., q − 1} 4. GenBPS: R_{Y} = P_{Y} + | 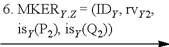 | |
| | | 7. VerifyID: Check that ID_{Y} exists |
| si_{Y1}(Q_{Y}), where si_{Y1} < o_{Y}_{^{e}}^{Y} | | and ID_{Y} (revoked) does not exists in |
| 5. CompSKS: sk_{Y}: Ei → Ei₂; | | the braid and any of the distributed |
| sk_{Y}(P₂) and sk_{Y} (Q₂); | | databases. |
| Add | | 8. |
| (ID_{Y}, rv_{Y2}, is_{Y}(P₂), is_{Y}(Q₂)) | | VerifySVals: |
| to any of the distributed | | (ID_{Y}, rv_{Y2}, is_{Y}(P₂), is_{Y}(Q₂)) |
| databases | | 9. GetSCPP: (Ei/ |
| | | Fₚ₂, p₁, P_{Y}, Q_{Y}, P_{Z}, Q_{Z},) |
| | | 10. GetRV: rv_{Z2} ∈ {1, . . . , q − 1} |
| | | 11. GenBPS: R_{Z} = P_{Z} + si_{Z1}(Q_{Z}), |
| | | where si_{ZI} < o₂_{^{e}}² |
| | | 12. CompSKS: sk_{Z}: Ei → Ei₃; |
| | 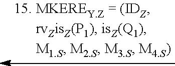 | sk_{Z}(P₁) and sk_{Z}(Q₁); Add (ID_{Z}, rv_{Z2}, is_{Z}(P₁), is_{Z}(Q₁)) to any of the distributed databases, where the public key of ID_{Z} is the |
| | | isogenous curve Ei₃ together |
| | | with sk_{Z}(P₁) and sk_{Z}(Q₁) |
| | | 13. CompMSKey: |
| | | po_{YZ} = is_{Y}(P₂) + si_{Z}(is_{Y}(Q₂)); |
| | | is_{YZ}: Ei₂ → Ei_{2,3} via po_{YZ}, |
| | | j(Ei_{2,3}) = j(Ei_{3,2}) = kₛᵢ, |
| 16. VerifySVals: | | where is_{ZY}: Ei₃ → Ei_{3,2} |
| (ID_{Z}, rv_{Z2}, is_{Z}(P₁), is_{Z}(Q₁)) | | kₘₛ = F′^{v} (Hash(kₛᵢ)) |
| | | 14. MSKeyIConfirm: |
| | | M_{1·S} = |
| | | Encₖ_{ₘₛ}(is_{Z}(P₁), is_{Y}(P₂), rv_{Z2}, rv_{Y2}); |
| | | M_{2·S} = MACₖ_{ₘₛ} (M_{1·S}); kₐ = |
| | | F″(Hash(kₘₛ, M_{2·S})); |
| | | M_{3·S} = Encₖ_{ₐ}(rv_{Z2}, rv_{Y2}); M_{4·S} = |
| | | MACₖ_{ₐ}(M_{3·S}) |
| 17. CompMSKey: | | |
| po_{ZY} = is_{Z}(P₁) + | | |
| si_{Y}(is_{Z}(Q₁)); | | |
| is_{ZY}: Ei₃ → Ei_{3, 2} via po_{ZY}; | | |
| j(Ei_{3,2}) = j(Ei_{2, 3}) = kₛᵢ, | | |
| where is_{YZ}: Ei₂ → Ei_{2, 3}; kₘₛ = F′^{v} (Hash(kₛᵢ)) 18. KeyEConfirm: | 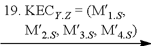 | 20. KeyEConfirm: VMACₖ_{ₘₛ} (M′_{2·S}) = M′_{1·S}; |
| VMACₖ_{ₘₛ}(M_{2·S}) = M_{1·S}, | | Decₖ_{ₘₛ}(M′_{1·S}) = |
| Decₖ_{ₘₛ}(M_{1·S}) = | | (is_{Z}(P₁), is_{Y}(P₂), rv_{Z2},rv_{Y2}); |
| (is_{Z}(P₁), is_{Y}(P₂), rv_{Z2}, rv_{Y2}); | | kₐ = F″ (Hash(kₘₛ, M′_{2·S}); |
| | | VMACₖ_{ₐ} (M′_{4·S}) = M′_{3·S}; |
| kₐ = F″(Hash(kₘₛ, M_{2·S}); | | Decₖ_{ₐ} (M′_{3·S}) = rv_{Z2}, rv_{Y2} |
| VMACₖ_{ₐ}(M_{4·S}) = M_{3·S}; | | |
| Decₖ_{ₐ} (M_{3·S}) = rv_{Z2}, rv_{Y2} | | |

The steps of the M-SIDH protocol are executed by a processor 105 using instructions stored in memory 109 in an order outlined in Table 2. In some implementations, the instructions are executed on a controller of a relevant IoT node, for example the node ID_{Y}, using instructions stored in memory 109 of the controller. The controller may have similar physical implementation as the processor 105.

The M-SIDH protocol starts with an initialization step where the node ID_{Y} verifies an identity of a node ID_{Z} with which the node ID_{Y} intends to transact, gets the SIDH public parameters and generates a random value rv_{Y2}. To verify the identity of ID_{Z}, the node ID_{Y} executes a command VerifyID discussed above which checks that the identity ID_{Z} exists and the identity ID_{Z} revoked) does not exists in the braid and any of the distributed databases. Additionally, during the initialization step, the node ID_{Y} invokes a GetSCPP command to get the SIDH public parameters (Ei/F_{P}_{²},p₁,P₁,Q₁,P₂,Q₂,) available in the braid or any of the distributed databases. For example, the controller of the node ID_{Y} under control of the instructions of GetSCPP may access the public parameters stored in the braid or query one of the distributed databases to provide the public parameters of SIDH. To generate a new ephemeral random value rv_{Y2}ϵ{1, . . . , q−1}, the node ID_{Y} invokes a command GetRV discussed above.

The node proceeds to generating a base point for SIDH by invoking the command GenBPS and computing a new ephemeral secret key for SIDH by invoking the command CompSKS using the generated base point.

In response to generating the new ephemeral secret key for SIDH, the node ID_{Y} proceeds to sending an M-SIDH based key establishment request SKER_{Y.Z}=(ID_{Y},rv_{Y2},is_{Y}(P₂),is_{Y}(Q₂)) to the node ID_{Z} and storing the request on the braid and/or any of the distributed databases. The M-SIDH based key establishment request comprises the identity of the node ID_{Y} generated the new ephemeral secret key, the new ephemeral random value rv_{Y2} and fixed points is_{Y}(P₂), is_{Y}(Q₂) representing new ephemeral public key generated using the new ephemeral secret key.

In response to receiving M-SIDH based key establishment request SKER_{Y.Z}, the node ID_{Z} also verified that the identity ID_{Y} of the node ID_{Y} exists and ID_{Y}(revoked) does not exists in the braid and any of the distributed databases in a similar manner described above. The node ID_{Z} also verifies that the received key establishment request (ID_{Y},rv_{Y2},is_{Y}(P₂),is_{Y}(Q₂)) exists in any of the distributed databases by executing a command VerifySVals: (ID_{Y},rv_{Y2},is_{Y}(P₂),is_{Y}(Q₂)) discussed above.

In response to successful verification, the node ID_{Z} proceeds to getting the SIDH public parameters (Ei/F_{P}_{²},p₁,P₁,Q₁,P₂,Q₂,) by executing the command GetSCPP, generating a new ephemeral random value rv_{Z2}ϵ{1, . . . , q−1} by executing the command GetRV, generating a base point R₂=P₂+si_{Z1}(Q₂), where si_{Z1}<o₂^{e}^{₂} for SIDH by invoking the command GenBPS and computing a new ephemeral secret key sk_{Z}:Ei→Ei₃ and corresponding public keys sk_{Z}(P₁) and sk_{Z}(Q₁) for SIDH by invoking the command CompSKS using the generated base point R₂.

In response to generating the new ephemeral secret key sk_{Z}:Ei→Ei₃ and corresponding public keys sk_{Z}(P₁) and sk_{Z}(Q₁) for SIDH, the node ID_{Z} proceeds to computing a mutually authenticated M-SIDH key by executing CompMSKey command to determine a mapping is_{YZ}: Ei₂→Ei_{2,3} via po_{YZ}=is_{Y}(P₂)+si_{Z}(is_{Y}(Q₂)). J variant j(Ei_{2,3}) of the image Ei_{2,3} of Ei₂ based on the mapping is_{YZ} is used as a shared secret key kₛᵢ for the nodes ID_{Z} and ID_{Y}. The node ID_{Z} derives the mutually authenticated M-SIDH key from the shared secret key kₛᵢ. In some implementations, the M-SIDH key is derived as kₘₛ=F′^{v}(Hash(kₛᵢ).

The node ID_{Z} additionally executes instructions for implicit key confirmation (KeyIConfirm) for kₘₛ by generate messages to the node ID_{Y} which can process the messages to ensure that ID_{Z} in fact has the mutually authenticated M-SIDH key kₘₛ.

Specifically, the node ID_{Z} sends an M-SIDH based key establishment reply MKERE_{Y.Z}=(ID_{Z},rv_{Z2},is_{Z}(P₁),is_{Z}(Q₁),M_{1.S},M_{2.S},M_{3.S},M_{4.S}) to the ID_{Y} node in response to generating messages for implicit key confirmation.

In response to receiving the M-SIDH based key establishment reply MKERE_{Y.Z}=(ID_{Z},rv_{Z2},is_{Z}(P₁),is_{Z}(Q₁),M_{1.S},M_{2.S},M_{3.S},M_{4.S}), the node ID_{Y} verifies the received data using the VerifySVals command and derives the same keys, i.e., kₛᵢ and kₘₛ, by executing the command CompMSKey using po_{ZY}=is_{Z}(P₁)+si_{Y}(is_{Z}(Q₁)).

Upon successful verification, the node ID_{Y} explicitly confirms the M-SIDH key by executing the KeyEConfirm command. In response to positive explicit key confirmation, the node ID_{Y} sends a key establishment confirmation KEC_{Y.Z}=(M_{1.S}′, M_{2.S}′,M_{3.S}′,M_{4.S}′) to the node ID_{Z}. Thus, the node ID_{Z} upon successful confirmation using the KeyEConfirm command is assured that ID_{Y} holds the same kₘₛ of the M-SIDH.

The M-SIDH is particularly advantageous to enhance protection of sensitive information against the threat of quantum computers. Similar to the M-ECDH, all the shared secret keys computed in the M-SIDH also expire within a short time. Without loss of generality, all nodes in Cryptiot are aware of the commands in the protocol suite.

Some implementations of the Cryptiot network also support a Distributed Consensus-based Key Establishment Protocol, a Non-Consensus-based Key Establishment Protocol, attachment strategies and a tip selection process.

### A Distributed Consensus-Based Key Establishment Protocol

The distributed consensus-based key establishment protocol (DC-KEP) is used to reach a distributed consensus on payment and non-payment functionality-based actual or pseudo transactions that are attached or to be attached to the braid. The DC-KEP is executed between a node ID_{Y} and a distributed master node ID_{DS1} where both nodes use a mutually authenticated key establishment protocol, for example, both ID_{Y} and ID_{DS1} use the M-ECDH to compute an M-ECDH key to support distributed consensus on a new actual transaction N. A sequence of steps of the distributed consensus-based key establishment protocol (DC-KEP) in accordance with one implementation of the present disclosure are shown in Table 3 below. Specifically, the implementation shown in Table 3 uses the M-ECDH key exchange. In alternative implementations, other mutually authenticated key exchange protocols can be used, for example M-SIDH discussed above.

TABLE 3
Sequence of steps of the Distributed Consensus-based Key Establishment Protocol

| ID_{Y} | | ID_{DS1} |
|---|---|---|
| 1. VerifyID: Check that IDDS1 | | |
| exists and ID_{DS1} (revoked) does | | |
| not exists in the braid and any of | | |
| the distributed databases. | 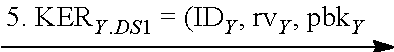 | |
| 2. GetECDP: (p, a, b, G, n, h) | | 6. VerifyID: Check that ID_{Y} |
| 3. GetRV: rv_{Y} ∈ {1, . . ., q − 1} | | exists and ID_{Y} (revoked) |
| 4. GenPK: pk_{Y} ∈ {1, . . ., n − 1}; | | does not exists in the braid |
| pbk_{Y} = pk_{Y} · G | | and any of the distributed |
| Add (ID_{Y}, rv_{Y}, pbk_{Y}) to any of the | | databases. |
| distributed databases | | 7. |
| | 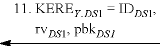 | Verify Vals: (ID_{Y}, rv_{Y}, pbk_{Y}) 8. |
| 12. | | GetECDP: (p, a, b, G, n, h) |
| Verify Vals: (ID_{DS1}, rv_{DS1}, pbk_{DS1}) | | 9. |
| 13. CompMKey: kₑ = pk_{Y} · pbk_{DS1}; | | GetRV: rv_{DS1} ∈ {1, . . ., q − |
| | | 1} |
| kₘ = F′(Hash(kₑ · rv_{Y} · rv_{DS1})) | | 10. |
| 14. ReqEPM: | | GenPK: pk_{DS1} ∈ {1, . . ., |
| M_{1·N} = Encₖ_{ₘ} (Hash(N), N); | | n − 1}; |
| M_{2·N} = MACₖ_{ₘ} (M_{1·N}) | | pbk_{DS1} = pk_{DS1}. G |
| | | Adds |
| | | (ID_{DS1}, rv_{DS1}, pbk_{DS1}) to |
| | | its database |
| 19. ExtractEP: VMACₖ_{ₘ} (M_{4·N}) = M_{3·N}; | 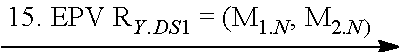 | 16. CompMKey: kₑ = |
| Decₖ_{ᵢᵢ} (M_{3·N}) = ptr_{N}; | | pk_{DS1} · pbk_{Y}; |
| ptr_{N} | | kₘ |
| = (AT_{N}, tp_{N}, info, Hash(N), N) | | = F′(Hash(kₑ · rv_{DS1} · rv_{Y})) |
| 20. | | 17. |
| Verify V: XMSS_{verify}_{_{xpbkDS1}} (v_{N}, M_{4·N}); v_{N} = XMSS_{Sign}_{_{xpkDS1}} (M_{4·N}) | 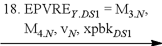 | GrantEPM: VMACₖ_{ₘ}(M_{2·N}) = M_{1·N}; Decₖ_{ₘ} (M_{1·N}) = |
| | | (Hash(N), N); |
| | | Verifies Hash(N) and |
| | | (Hash(N), N) |
| | | ptr_{N} = |
| | | (AT_{N}, tp_{N}, info, Hash (N), N; |
| | | M_{3·N} = Encₖ_{ₘ} (ptr₁); |
| | | M_{4·N} = MACₖ_{ₘ} (M_{3·N}); |
| | | v_{N} = |
| | | XMSS_{Sign}_{_{xpkDS1}} (M_{4·N}); |

As shown in Table 3, the node ID_{Y} verifies identity of a distributed master node by executing the command VerifyID using the identifier ID_{DS1} of the distributed master node ID_{DS1}. Specifically, the IoT node ID_{Y} checks that ID_{DS1} exists and ID_{DS1}(revoked) does not exists in the braid and any of the distributed databases. Additionally, the IoT node ID_{Y} gets elliptic curve domain parameters (p, a, b, G, n, h) by executing the command GetECDP discussed above and generates an ephemeral random value rv_{Y}ϵ{1, . . . , q−1} by executing the command GetRV. The node ID_{Y} also generates an ephemeral private key pk_{Y}ϵ{1, . . . , n−1} by executing the command GenPK using the elliptic curve domain parameters and the generated random value. Once the new ephemeral private key is generated, the node ID_{Y} sends a key establishment request KER_{Y.DS1}=(ID_{Y},rv_{Y},pbk_{Y}) to the distributed master node ID_{DS1}. The key establishment request KER_{Y.DS1} include the identifies of the IoT node ID_{Y} attempting to create a transaction, the ephemeral random value rv_{Y} and an ephemeral public key corresponding to the generated private key pk_{Y}.

The distributed master node ID_{DS1} in turn verifies identity of the IoT node ID_{Y} which sent the request by executing the command VerifyID using the identity ID_{Y} of the IoT node ID_{Y} to check that ID_{Y} exists and ID_{Y}(revoked) does not exists in the braid and any of the distributed databases. If the identity ID_{Y} of the IoT node is confirmed, the distributed master node ID_{DS1} verifies the received key establishment request by executing the command Verify Vals which verifies the public values (ID_{Y},rv_{Y},pbk_{Y}) received in the key establishment request KER_{Y.DS1}. Specifically, the distributed master node verifies that the received public values exists in any of the distributed databases.

In response to confirming that all values exist in any of the distributed databases, the distributed master node ID_{DS1} also determines the elliptic curve domain parameters (p, a, b, G, n, h) by executing the command GetECDP, generates a new ephemeral random value rv_{DS1}ϵ{1, . . . , q−1} by executing the command GetRV:rv_{DS1}ϵ{1, . . . , q−1} and generates a new ephemeral private key pk_{DS1}ϵ{1, . . . , n−1} by executing the command GenPK using the determined elliptic curve parameters and the new ephemeral random value. The distributed master node ID_{DS1} also determined a public key pbk_{DS1} corresponding to the generated ephemeral private pbk_{DS1}=pk_{DS1}·G in a manner know to a person skilled in the art. Once the ephemeral public key has been generated, the distributed master node ID_{DS1} stores (ID_{DS1},rv_{DS1},pbk_{DS1}) the generated ephemeral random value rv_{DS1} and the generated ephemeral public key pbk_{DS1} in association with the identity ID_{DS1} in a corresponding database.

Once the public values (ID_{DS1},rv_{DS1},pbk_{DS1}) are stored in one of the distributed databases, the distributed master node ID_{DS1} proceeds to responding to the request by providing a key establishment reply KERE_{Y.DS1}=(ID_{DS1},rv_{DS1},pbk_{DS1}) comprising the identity of the distributed master node ID_{DS1}, the ephemeral random value rv_{DS1} and the generated ephemeral public key pbk_{DS1}.

On receipt of the key establishment reply KERE_{Y.DS1}=(ID_{DS1},rv_{DS1},pbk_{DS1}), the IoT node ID_{Y} again verifies received public values (ID_{DS1},rv_{DS1},pbk_{DS1}) using the command Verify Vals as discussed above. In response to successful verification, the IoT node ID_{Y} computes a shared key kₑ=pk_{Y}·pbk_{DS1} by executing the command CompMKey using the private key of the IoT node ID_{Y} and the public key of the distributed master node ID_{DS1}. The IoT node ID_{Y} also determines an M-ECDH key kₘ using the shared key. In some implementations, the M-ECDH key kₘ is determined as kₘ=F′(Hash(kₑ·rv_{Y}·rv_{DS1})) using the shared key and the ephemeral random values generated by the IoT node and the distributed master node to further enhance security of the system.

The IoT node additionally requests a tips pointer and a verifier for a new actual transaction by executing the ReqEPM command by encrypting the transaction data using the generated M-ECDH key kₘ. In some implementations, the IoT node generates two messages. The first message M_{1.N}=Encₖ_{ₘ}(Hash(N),N) comprising a hash value of the transaction data concatenated with the transaction data and encrypted, using the M-ECDH key kₘ. The second message M_{2.N}=MACₖ_{ₘ}(M_{1.N}) is a signature or a message authentication code (MAC) determined using the M-ECDH key kₘ for the first message. The IoT node ID_{Y} sends a tips pointer and a verifier request EPV R_{Y.DS1}=(M_{1.N},M_{2.N}) comprising the generated messages to the distributed master node ID_{DS1}.

Upon receipt of the tips pointer and a verifier request from the IoT node, the distributed master node ID_{DS1} determined the M-ECDH key kₘ based on the private key of the distributed master node and the public key of the IoT node. In some implementations, the M-ECDH key kₘ is determined by executing the CompMKey command which determined kₑ=pk_{DS1}·pbk_{Y} and kₘ=F′(Hash(kₑ·rv_{DS1}·rv_{Y})). Additionally, the distributed master node ID_{DS1} grants a tips pointer and a verifier for a new actual transaction in response to verifying the request EPV R_{Y.DS1}=(M_{1.N},M_{2.N}). Specifically, the distributed master node ID_{DS1} executed the GrantEPM command which verifies the signature M_{2.N} using the key kₘ by computing VMACₖ_{ₘ}(M_{2.N}). If the signature is verified successfully, i.e. VMACₖ_{ₘ}(M_{2.N})=M_{1.N}, the distributed master node ID_{DS1} decrypts the first message M_{1.N} Decₖ_{ₘ}(M_{1.N})=(Hash(N),N) using the key kₘ to determine Hash(N),N and verify Hash(N) and (Hash(N),N). In other words, the distributed master node ID_{DS1} computes a hash value of N from the decrypted message Decₖ_{ₘ}(M_{1.N}) and compares the computed hash value with Hash(N) from the decrypted message Hash(N), if the values are the same, the distributed master node ID_{DS1} deems that the key kₘ is confirmed and grants a tips pointer ptr_{N} and a verifier v_{N} by providing the tips pointer and verifier reply EPVRE_{Y.DS1}=(M_{3.N},M_{4.N},v_{N},xpbk_{DS1}). The tips pointer and verifier reply comprises an encrypted tips pointer M_{3.N}=Encₖ_{ₘ}(ptr_{N}) using the key kₘ, a message authentication code M_{4.N}=MACₖ_{ₘ}(M_{3.N}) of the encrypted tips pointer, a verifier

$${v}_{N} = {XMSS}_{{Sign}_{{xpk}_{DS 1}}} ( {M}_{4. N} )$$

as an XMSS signature of the message authentication code M_{4.N} determined using an XMSS private key of the distributed master node ID_{DS1}. The tips pointer can be generated as an array ptr_{N}=(AT_{N},tp_{N},info,Hash(N),N) comprising a list of available tips, a time stamp, additional information, a hash value of the transaction data and the transaction data.

In response to receiving the tips pointer and verifier reply, the IoT node ID_{Y} extracts the tops pointer ptr_{N} from M_{3.N} using the key kₘ, confirms the tips pointer and the verifier using M_{4.N}. If all the verifications in the DC-KEP succeed, the IoT node ID_{Y} and the distributed master node ID_{DS1} reach a distributed consensus on new actual transaction N and the transaction can be added to the braid.

### A Non-Consensus-Based Key Establishment Protocol

The non-consensus-based key establishment protocol (NC-KEP) is used to establish and exchange non-payment functionality-based actual or pseudo transactions that are not attached to the braid. In this case, nodes can use NC-KEP to strengthen the security of transactions in Cryptiot.

TABLE 4
Sequence of steps of the Non-Consensus-based Key Establishment Protocol (NC-KEP)

| ID_{Y} | | ID_{Z} |
|---|---|---|
| 1. VerifyID: Check that ID_{Z} | | |
| exists and ID_{Z} (revoked) does | | |
| not exists in the braid and any of | | |
| the distributed databases. | 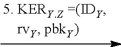 | 6. VerifyID: Check that ID_{Y} exists and ID_{Y} (revoked) does not exists |
| 2. GetECDP: (p, a, b, G, n, h) | | in the braid and any of the |
| 3. GetRV: rv_{Y} ∈ {1, . . . , q − 1} | | distributed databases. |
| 4. GenPK: pk_{Y} ∈ {1, . . . , n − 1}; | | 7. Verify Vals: (ID_{Y}, rv_{Y}, pbk_{Y}) |
| pbk_{Y} = pk_{Y} · G; | | 8. GetECDP: (p, a, b, G, n, h) |
| Add (ID_{Y}, rv_{Y}, pbk_{Y}) to any of | | 9. GetRV: rv_{Z} ∈ {1, . . . , q − 1} |
| the distributed databases | 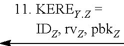 | 10. GenPK: pk_{Z} ∈ {1, . . . , n − 1}; pbk_{Z} = pk_{Z} · G; Adds (ID_{Z}, rv_{Z}, pbk_{Z}) to any of the distributed databases |
| 12. Verify Vals: (ID_{Z}, rv_{Z}, pbk_{Z}) | | |
| 13. CompMKey: kₑ = pk_{Y} · pbk_{Z}; kₘ = F′(Hash(ke · rv_{Y} · rv_{Z})) | 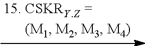 | 16. CompMKey: kₑ = pk_{DS1}.pbk_{Y}; kₘ = F′(Hash(kₑ · rv_{DS1} · rv_{Y})) |
| 14. MKeyIConfirm: | | 17. KeyEConfirm: VMACₖ_{ₘ} (M₂) = |
| M₁ = | | M₁; |
| Encₖ_{ₘ} (pk_{Y}, pk_{Z}, rv_{Y}, rv_{Z}); M₂ = MACₖ_{ₘ} (M₁); kₐ = F″(Hash(kₘ,M₂)); | 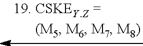 | Decₖ_{ₘ} (M₁) = pk_{Y}, pk_{Z}, rv_{Y}, TV_{Z}; kₐ = Hash(kₘ, M₂); VMACₖ_{ₐ}(M₄) = M₃; |
| M₃ = Encka (rv_{Y}, TV_{Z}); M₄ = | | Decₖ_{ₐ}, (M₃) = rv_{Y}, rv_{Z} |
| MACₖ_{ₐ}(M₃) | 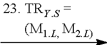 | 18. MKeyIConfirm: M₅ = Encₖ_{ₘ} (pk_{Y}, pk_{Z}, rv_{Y}, rv_{Z}); M₆ = MACₘ (M₅); kₐ₂ = |
| 20. KeyEConfirm: | | F″(Hash(kₘ, M₆)); |
| VMACₖ_{ₘ} (M₆) = M₅; | | M₇ = Encₖ_{_{a.2}} (rv_{Y}, rv_{Z}); M₈ = |
| Decₖ_{ₘ} (M₅) = | | MACₖ_{_{a.2}} (M₇) |
| pk_{Y}, pk_{Z}, rv_{Y}, rv_{Z}; | | |
| kₐ₂ = F″(Hash(kₘ, M₆)); | | |
| VMAC_{K}_{_{a.2}} (M₈) = M₇; | | 24. CompSKey: |
| Decₖ_{_{a.2}} (M₇) = rv_{Y}, rv_{Z} | | kₛ = F′′′ (Hash(kₘ, kₐ, rv_{Y}, rv_{Z})) |
| 21. CompSKey: | | 25. O_SKeyusage: |
| kₛ | | VMACₖ_{ₛ} (M_{2.L}) = M_{1.L}; |
| = F′′′(Hash(kₘ, kₐ, rv_{Y}, rv_{Z})) | | Decₖ_{ₛ} (M_{1.L}) = (Hash (L), L) |
| 22. S_SKeyusage: M_{1.L} = | | |
| Encₖ_{ₛ} (Hash (L), L); | | |
| M_{2.L} = MAC(M_{1.L}) | | |

The NC-KEP is executed between two nodes, for example nodes ID_{Y} and ID_{Z} (see Table 4 above), where both IoT nodes ID_{Y} and ID_{Z} use their derived shared secret session key k_{S} to securely establish and exchange a non-payment functionality-based actual transactions. The steps 1-13 shown in Table 4 are similar to the steps 1-13 discussed above with references to Table 3, albeit the IoT node ID_{Y} is communicating with the IoT node ID_{Z} rather than the distributed master node ID_{DS1}. For example, the IoT node ID_{Y} sends a key establishment request KER_{Y.Z}=(ID_{Y},rv_{Y},pbk_{Y}) to the IoT node ID_{Z} in step 5, and, upon receiving ID_{Z} 's response, the IoT node ID_{Y} derives an M-ECDH key kₘ in step 13.

The IoT node ID_{Y} uses the derived M-ECDH key kₘ to perform implicit key confirmation by executing the MKeyIConfirm command which generates four messages:

M₁=Encₖ_{ₘ}(pk_{Y},pbk_{Z},rv_{Y},rv_{Z});

M₂=MACₖ_{ₘ}(M₁);kₐ=F″(Hash(kₘ,M₂));

M₃=Encₖ_{ₐ}(rv_{Y},rv_{Z}); and

M₄=MACₖ_{ₐ}(M₃).

Once the messages are generated, the node ID_{Y} generates and sends a shared secret session key request CSKR_{Y.Z}=(M₁,M₂,M₃,M₄) to the IoT node ID_{Z} comprising the four messages.

The IoT node ID_{Z} also generates the M-ECDH key kₘ in the similar manners as discussed above with references to Table 3, performs explicit and implicit key confirmations, and responds to the IoT node ID_{Y} with the shared secret session key reply CSKE_{Y.Z}=(M₅,M₆,M₇,M₈). The IoT node ID_{Y} computes a compute shared secret session key k_{S} based on the M-ECDH key kₘ, the assurance key kₐ and the ephemeral random values rv_{Y}, rv_{Z} as k_{S}=F′″(Hash(kₘ,kₐ,rv_{Y},rv_{Z})).

In response to determining shared secret session key k_{S}, the IoT node uses the shared secret session key k_{S} to establish a non-payment functionality-based actual transaction L by sending a transaction request TR_{Y.Z}=(M_{1.L},M_{2.L}) to the IoT node ID_{Z}. The transaction request TR_{Y.Z} comprises two messages M_{1.L}=Encₖ_{_{S}}(Hash(L),L) corresponding to encrypted transaction data of the transaction L using the shared session key and M_{2.L}=MAC(M_{1.L}) corresponding to a message authentication code of M_{1.L} determined using the shared session key.

Upon receiving the transaction request TR_{Y.Z}, the IoT node ID_{Z} computes the shared session key k_{S} in the same matter the IoT node ID_{Y} and uses the determined shared session key k_{S} to obtain transaction data L from the received transaction request TR_{Y.Z}. Specifically, the IoT node ID_{Z} verifies the message authentication code M_{2.L} by computing VMACₖ_{_{S}}(M_{2.L}) using the shared session key and comparing VMACₖ_{_{S}}(M_{2.L}) against M_{1.L}. If VMACₖ_{_{S}}(M_{2.L})=M_{1.L}, the IoT node ID_{Z} decrypts M_{1.L} by computing Decₖ_{_{S}}(M_{1.L}) using the shared session key to determine (Hash(L),L), i.e. Decₖ_{_{S}}(M_{1.L})=(Hash(L),L)

If all the verifications in the NC-KEP succeed, the nodes ID_{Y} and ID_{Z} can securely exchange L and related responses or transactions. The transaction L is not stored on the braid. Based on the key establishment properties, no other node learns anything about the shared secret session key k_{S}. Note that after the use of k_{S}, ID_{Y} and ID_{Z} will compute new shared secret session keys for new transactions.

To issue an ID to a node, a (payment or non-payment functionality-based) identity issuing actual transaction is established by the node requesting issuance of the ID. On completion of the identity issuing actual transaction, an ID is issued to the node by the distributed master node. The distributed master node uses Distributed Consensus-based Key Establishment Protocol (DC-KEP) to establish a non-payment functionality-based identity issued actual transaction with another distributed master node to reach a consensus on the transaction and store the transaction on the braid. In this case, the actual transaction represents an identity issued actual transaction. Upon the successful execution of DC-KEP, the distributed master node issues ID to the IoT node and stores the transaction on the braid.

To revoke the issued identity ID, a (payment or non-payment functionality-based) identity revocation actual transaction is established by the distributed master node. At the end of the transaction, an ID(revoked) is returned to the node by the distributed master node. The distributed master node also uses DC-KEP to establish a (non-payment functionality-based) identity revoked actual transaction with another distributed master node to reach a distributed consensus on the transaction and store it on the braid and any of the distributed databases. In this case, the actual transaction represents an identity revocation actual transaction. Upon the successful execution of DC-KEP, the distributed master returns ID(revoked) to the IoT node and stores the transaction on the braid and any of the distributed databases. By following the above procedure, fair issuing (or revocation) of the ID is done by reaching distributed consensus on the transaction.

The DC-KEP and NC-KEP protocols provide the following advantages to ensure the security and privacy of the nodes and transactions:
(I) Nodes do not reveal their secrets during the execution of the protocols, and the secrets are neither stored on the braid nor the distributed databases;
(II) A unique identity can be derived and revoked for every node;
(III) Sensitive information, such as private keys of a node from the records of the protocols and transactions, is not leaked, i.e. transactional privacy is preserved.

### Attachment Strategies

Different attachment strategies may be employed for attaching a transaction to the braid. Some of the attachment strategies are discussed below. In some implementations, to issue a new transaction and further mitigate spamming and other related attacks, every node goes through a tip selection process to select a tip and attach the new transaction to the selected tip.

Any validated tip in the braid can be selected as a place for a new transaction attachment since the importance of all validated tips in the braid are equal by default. The Fuzzy-Analytical Hierarchical Process (F-AHP) of the present disclosure makes a choice of hierarchically selecting a validated tip from among several validated tips. The Fuzzy Analytic Hierarchy Process is a method of Analytic Hierarchy Process (AHP) developed with fuzzy logic theory where a fuzzy triangle scale is used instead of the AHP scale to determine priority. In a general AHP model, the hierarchy levels include the objective (first level), criteria (second level), sub-criteria (third level), and alternatives (fourth level). The pairwise comparisons of both criteria and alternatives is implemented using triangular numbers corresponding to fuzzy logic preferences according to the disclosed implementation of the F-AHP. For example, a tip can be selected based on essential metrics such as transaction type, weight, and address. The F-AHP allows to compare and organise the metrics, shows the impact the metrics have on one another, and helps an IoT node to find a tip based on preferences of the IoT node.

The representation of the objective, criterion, and alternatives is schematically shown in FIG. 6. As shown in FIG. 6, the “objective” 610 of using the F-AHP can be set as hierarchically selecting a validated tip to attach a new transaction to the braid. The criterion of the F-AHP 620 can be set as a transaction type. The alternatives 630, 635 and 640 can be set as available tips (or validated transactions D, E, and F) in the list of available transactions AT_{N} discussed above. The F-AHP is described in more detail below.

The F-AHP uses triangular numbers represented in Table 5 below to describe the average pairwise comparison of the alternative according to preferences of an IoT node. The triangular numbers are also used to form the comparison matrix for the alternatives. For example, if a node, e.g. an IoT node ID_{Y}, states that the tip D is fairly more important than the tip E, then the fuzzy triangular scale is (4,5,6). On the other hand, in the pairwise contribution matrix of the alternatives, comparison of E to D takes the fuzzy triangular scale as (⅙, ⅕, ¼). The pairwise comparison matrix can be written as follows:

$${\tilde{X}}^{k} = [ \begin{matrix}{\tilde{a}}_{11}^{k} & … & {\tilde{a}}_{1 n}^{k} \\ ⋮ & ⋱ & ⋮ \\ {\tilde{a}}_{n 1}^{k} & … & {\tilde{a}}_{nn}^{k}\end{matrix} ] \qquad ( 2 )$$

where ãᵢⱼ^{k} represents k^{th} preference of i^{th} alternative over j^{th} of the IoT node ID_{Y} via the triangular numbers.

TABLE 5
Linguistic terms and their triangular numbers

| | | Triangular |
|---|---|---|
| Scale | Description | numbers |
| 1 | Equal importance between two elements (EI) | (1, 1, 1) |
| 3 | One element is weakly important than the other (WI) | (2, 3, 4) |
| 5 | One element is fairly important than the other (FI) | (4, 5, 6) |
| 7 | One element is strongly more important than the | (6, 7, 8) |
| | other (SI) | |
| 9 | One element is absolutely more important than the | (9, 9, 9) |
| | other (AI) | |
| 2 | The intermediate value between two nearby scales | (1, 2, 3) |
| 4 | | (3, 4, 5) |
| 6 | | (5, 6, 7) |
| 8 | | (7, 8, 9) |

Example average pairwise comparison of the D, E, and F according to preference of ID_{Y} is shown in Table 6.

TABLE 6
Pairwise Comparisons of the alternatives
via triangular numbers

| AI | SI | FI | WI | | EI | |
|---|---|---|---|---|---|---|
| (9, 9, 9) | (6, 7, 8) | (4, 5, 6) | (2, 3, 4) | Alternative | (1, 1, 1) | Alternative |
| | | | | D | Yes | E |
| | Yes | | | D | | F |
| | Yes | | | E | | F |

An example pairwise comparison matrix for the preferences of the IoT node ID_{Y} form Table 6 is shown Table 7.

TABLE 7
Pairwise comparison matrix of the alternatives

| Alternative | D | E | F |
|---|---|---|---|
| D | (1, 1, 1) | (1, 1, 1) | (6, 7, 8) |
| E | (1, 1, 1) | (1, 1, 1) | (4, 5, 6) |
| F | (⅛, 1/7, ⅙) | (⅛, 1/7, ⅙) | (1, 1, 1) |

FIG. 13 shows a method 1300 of selecting an attachment tip in accordance with one implementation of the present disclosure. The method 1300 may be executed on a processor 105 under control of instructions stored in memory 109.

The method 1300 commences at a step 1310 of receiving a list of available tips. For example, the list AT_{B}=(D,E,F,G,H,I,J,K) or the list AT_{N}=(D,E,F,G,H,I,J,K) can be received from the distributed master node 187 or determined by a node 185. Each tip in the list may be considered as an alternative for F-AHP. Step 1310 proceeds to a step 1320 of generating a pairwise comparison matrix for the available tips based on preference of the node requesting the tip. For example, the node may prefer actual tips versus pseudo tips, tips with higher weight etc. An example pairwise comparison matrix is shown in table 7. The pairwise comparison matrix may be generated as shown above.

Execution of the method 1300 continues from step 1320 to a step 1330 of determining a weight for each tip based on the generated pairwise comparison matrix. The weight can be determined in various ways, for example, by determining a geometric mean, determining a normalised weight, etc. Example methods of determining the weight are disclosed below.

Step 1330 continues to a step 1340 of prioritising available tips based on the determined weights. For example, the tips can be prioritised by ordering the tip according to the determined weight in descending order. Step 1340 proceeds to a step 1350 of outputting a preferred tip to the node. The method 1300 concludes on completion of step 1350.

In some implementations, the weight may be determined as follows. First, the geometric mean \tilde{g}ᵢ of the fuzzy comparison values can be calculated for each alternative using Equation (3) below:

$${\tilde{g}}_{i} = {( {\prod }_{j = 1}^{n} {\tilde{a}}_{ij} )}^{1 / n} , \qquad ( 3 )$$

$$i = 1 , 2 , … , n$$

Example geometric mean of fuzzy comparison values of D, E, and F are calculated using Equation (3) and the results are shown below in Table 8.

$${\tilde{g}}_{i} ( D ) = {( {\prod }_{j = 1}^{n} {\tilde{a}}_{ij} )}^{\frac{1}{n}} = [ {( 1 * 1 * 6 )}^{\frac{1}{3}} ; {( 1 * 1 * 7 )}^{\frac{1}{3}} ; {( 1 * 1 * 8 )}^{\frac{1}{3}} ] = [ 1.82 ; 1.91 ; 1.99 ]$$

$${\tilde{g}}_{i} ( E ) = {( {\prod }_{j = 1}^{n} {\tilde{a}}_{ij} )}^{\frac{1}{n}} = [ {( 1 * 1 * 4 )}^{\frac{1}{3}} ; {( 1 * 1 * 5 )}^{\frac{1}{3}} ; {( 1 * 1 * 6 )}^{\frac{1}{3}} ] = [ 1.59 ; 1.71 ; 1.82 ]$$

$${\tilde{g}}_{i} ( F ) = {( {\prod }_{j = 1}^{n} {\tilde{a}}_{ij} )}^{\frac{1}{n}} = [ {( 1 / 8 * 1 / 8 * 1 )}^{\frac{1}{3}} ; {( 1 / 7 * 1 / 7 * 1 )}^{\frac{1}{3}} ; {( 1 / 6 * 1 / 6 * 1 )}^{\frac{1}{3}} ] = [ 0.25 ; 0.27 ; 0.30 ]$$

TABLE 8
Geometric means of the fuzzy comparison values

| | |
|---|---|
| Alternative | \tilde{g}ᵢ |

| | | | |
|---|---|---|---|
| D | 1.82 | 1.91 | 1.99 |
| E | 1.59 | 1.71 | 1.82 |
| F | 0.25 | 0.27 | 0.30 |
| Total | 3.66 | 3.89 | 4.11 |
| Inverse of summation vector (reverse of | 0.27 | 0.26 | 0.24 |
| total = power of −1) | | | |
| Increasing order (reverse vector [symbol] ) | 0.24 | 0.26 | 0.27 |

A fuzzy weight can be calculated for each alternative using the geometric mean of fuzzy comparison values. The fuzzy weight \tilde{w}ᵢ for an alternative i is calculated by multiplying each component \tilde{g}ᵢ with a reverse vector component [symbol] . The reverse vector [symbol] is determined by determining the vector summation of each \tilde{g}ᵢ rearranging the triangular numbers of the vector summation in an increasing order.

$${\tilde{w}}_{i} = {\tilde{g}}_{1} \times ; {\tilde{g}}_{2} \times ; {\tilde{g}}_{3} \times ; … ; {\tilde{g}}_{n} \times \qquad ( 4 )$$

The fuzzy weight of each alternative is calculated using Equation (4) and the results are shown below and in Table 9.

\tilde{w}ᵢ(D)=[(1.82*0.24);(1.91*0.26);(1.99*0.27)]=[0.4368;0.4966;0.5373]

\tilde{w}ᵢ(E)=[(1.59*0.24);(1.71*0.26);(1.82*0.27)]=[0.3816;0.4446;0.4914]

\tilde{w}ᵢ(F)=[(0.25*0.24);(0.27*0.26);(0.30*0.27)]=[0.06;0.0702;0.081]

TABLE 9
Relative fuzzy weight of each alternative

| Alternative | \tilde{w}₁ | | |
|---|---|---|---|
| D | 0.4368 | 0.4966 | 0.5373 |
| E | 0.3816 | 0.4446 | 0.4914 |
| F | 0.06 | 0.0702 | 0.081 |

The F-AHP proceeds to calculating a non-fuzzy weight mwᵢ of each alternative as an average of components of \tilde{w}₁ and normalized weight nw_{i;} of each alternative.

$${mw}_{i} = \frac{{\sum }_{i = 1}^{n} {\tilde{w}}_{i}}{n} \qquad ( 5 )$$

$${nw}_{i} = \frac{{mw}_{i}}{{\sum }_{i = 1}^{n} {mw}_{i}} \qquad ( 6 )$$

Non-fuzzy weights mwᵢ and normalized weights nwᵢ determined using Equations (5) and (6), respectively, for the above example preferences of the IoT node ID_{Y} are shown in Table 10:

TABLE 10
Non-fuzzy and normalized weight of each alternative

| Alternative | mwᵢ | nwᵢ |
|---|---|---|
| D | 0.4902 | 0.4903 |
| E | 0.4392 | 0.4393 |
| F | 0.0704 | 0.0704 |

The alternatives can be ordered in a decreasing order of the determined normalized weights to determine a hierarchy of preferred attachment tips. For example, based on the preferences of the ID_{Y} node, the tip D has the largest normalized weight or score. Therefore, the tip D can be selected as the best tip among three of the tips followed by E and F.

It should be noted that more tips can be added as alternatives and the F-AHP algorithm is executed accordingly. Additionally or alternatively, a combination of criteria (such as transaction type, weight, and address) and alternatives (such as transactions D, E, F, G, and H) can also be used for the F-AHP algorithm. In this case, the F-AHP algorithm will be carried out for the criteria to determine a normalized weight for each criterion and also carried out for each alternative. Results for each alternative according to each criterion can be calculated by multiplying each alternative normalize weight with normalize weight of each criterion. An alternative with the largest total weight can be selected as an attachment tip.

As can be seen above, not only the alternative D has the largest score, the calculated values for the alternative D are the largest at the end of every step of the F_AHP algorithm. Accordingly, in some implementations, the ID_{Y} node can finalise the F-AHP algorithm at the end of any of the steps discussed above, i.e. prior to determining the normalized weight, to enhance Cryptiot's performance.

The discussed attachment strategy using the F-AHP method provides a hierarchical structure of selecting a validated tip for attaching a new transaction which advantageously improves and simplifies decision-making during tip selection.

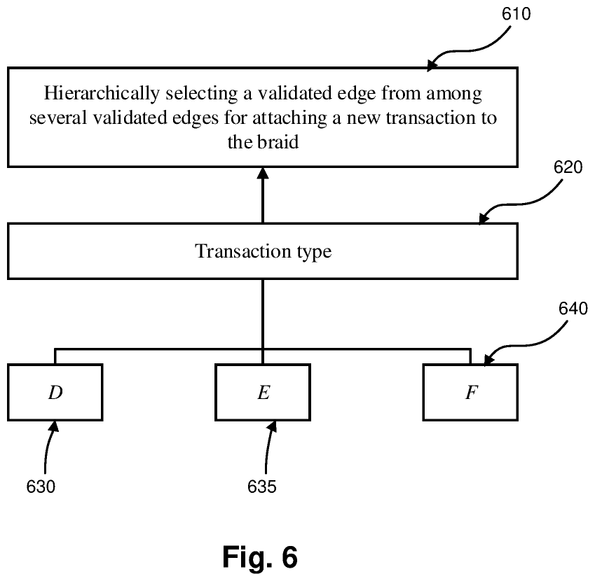

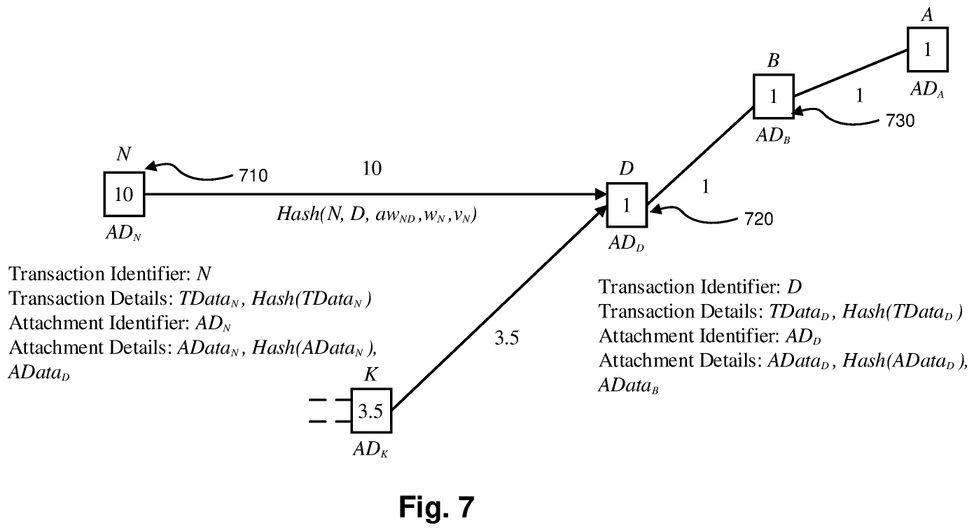

FIG. 7 demonstrates a process of adding a new transaction to the braid 300. To attach the new actual transaction N 710 to a selected tip, for example the tip D 720, with a parent tip B 730 as shown in FIG. 7, the IoT node ID_{Y} first computes Hash(D(attached)) and verifies whether (D,Hash(D(attached)) does not already exists in the braid and any of the distributed databases. If (D,Hash(D(attached)) does not already exists in the braid and any of the distributed databases, the IoT node ID_{Y} verifies the attachment weight aw DB between D and the parent transaction of D, i.e., B. If the calculated attachment weight corresponds to the attachment weight in the braid, the IoT node ID_{Y} proceeds as follows:
1. The IoT node ID_{Y} computes an attachment weight aw_{ND}=(w_{N}/w_{D}) for the new transaction N;
2. The IoT node ID_{Y} attaches the transaction N to D (braid) by generating an attachment tag at_{N}=Hash(N,D,Hash(D(attached)),aw_{ND},w_{N},v_{N});
3. The IoT node ID_{Y} prepares an attachment identifier AD_{N}=(AData_{N},Hash(AData_{N}),AData_{D}) for the new transaction N and sends messages M_{AD}_{_{N.1}}=Encₖ_{ᵢᵢ}(AD_{N}) and M_{AD}_{_{N.2}}=MACₖ_{ᵢᵢ}(M_{AD}_{_{N.1}}) to a distributed master node ID_{DS1} to store in the distributed database, where AData_{N}=(N,D,Hash(N(attached)),tp_{N},aw_{ND},w_{N},v_{N},xpbk_{DS1},ptr_{N}) is attachment data of N,tp_{N} is a timestamp indicating the time at_{N} was generated, w_{N} is weight of N, v_{N} is verifier of N, xpbk_{DS1} is XMSS public key of ID_{DS1} that issued v_{N}, and ptr_{N} is tips pointer for N.
4. Upon receiving M_{AD}_{_{N.1}} and M_{AD}_{_{N.2}}, the distributed master node ID_{DS1} computes VMACₖ_{ᵢᵢ}(M_{AD}_{_{N.2}})=M_{AD}_{_{N.1}} and Decₖ_{ᵢᵢ}(M_{AD}_{_{N.2}})=AD_{N}, verifies that N has been attached to D in the braid, compute Hash(N(attached)), and verifies whether N and Hash(N(attached) exist in the attachment identifier AD_{N} and do not already exist in any of the distributed databases, and stores the attachment identifier AD_{N} in a corresponding distributed database of the distributed master node ID_{DS1} if the verifications succeeds.
5. In response to successful verification, i.e. when the distributed master node ID_{DS1} responds with okay to the IoT node ID_{Y}, the new transaction N is assumed to become visible to the Cryptiot network at time t_{N.1}+t_{N.2}, where t_{N.1} is the time the IoT node ID_{Y} observes the state of the braid before issuing N and t_{N.2} is the time N is attached to the braid. Thus, N becomes available in the braid before ID_{DS1}'s verification.

The attachment identifier AD_{N} can be used by nodes for verification of an attachment tag at_{Y}. Furthermore, the attachment identifier AD_{N} contains the transaction's identifier N and also the transaction identifier D of the tip that is connecting to thus creating a chain of transactions all the way to the genesis transaction. The computation and verification of Hash(D(attached)) and Hash(N(attached)) are used to mitigate splitting attack as discussed below in more detail.

Additionally, transactions can be verified using the braid (i.e., a form of on-braid verification) and attachment identifiers can be verified using the distributed databases (i.e., a form of off-braid verification). In some implementations, the distributed databases do not store any secret information. It is assumed that if two transactions are valid, the attachment between them is valid without loss of generality.

FIG. 14B shows a flow chart of a method 1455 in accordance with one implementation of method 1400. The method 1455 may be executed on a processor 105 of a node 187 or 185 under control of instructions stored in memory 109.

The method 1455 commences at a step 1460 of receiving a request by the node, the request being associated with a transaction. For example, the request may be a request to exchange non-payment transactions, add new transaction to the braid 200, retract a transaction from the braid 200, convert a transaction to a non-retractable transaction, revoke an identity or any other request. As discussed above, in some implementations, only a node which created a retractable transaction may request retraction of that transaction and/or conversion of the retractable transaction to a non-retractable transaction.

Step 1460 proceeds to a step 1465 of determining a type of the transaction based on the request. As discussed above, in some implementations, the type of the transaction can be extracted from the request. Alternatively, if the request relates to an existing transaction, the method 1465 may determine the type of the transaction by identifying the transaction in the data structure, i.e. the braid. A transaction type can be selected from a plurality of types including a payment transaction, an identity creation transaction, an identity revocation transaction, a file transfer transaction etc.

The method 1455 continues from step 1465 to a step 1470 of determining whether the transaction relates to payment or not based on the transaction type. Payment related transactions are considered to include payment transactions as well as transaction related to creation and revocation of node identities. If the processor 105 determines that the transaction is not related to payment functionality, the method 1455 proceeds to step 1475 of using the NC-KEP to exchange the transactions. In some implementations, only a record of the non-payment transaction, as opposed to the transaction itself, may be stored in the data structure. For example, step 1475 may proceed to a step 1478 of generating a request to add a record of the transaction to the data structure, e.g. braid, and using the using the DC-KEP at step 1490 to grant the request.

Returning to step 1470, the method 1455 proceeds to a step 1480 of checking whether the request is valid if the transaction is determined to be a payment transaction. Validity of the request can be verified based on the type of the transaction. In some implementations, step 1480 involves identifying a transaction in the data structure based on the request. In some implementations, validity of the request can be checked by executing verification commands of VerifyID, Verify Vals and GrantEPM or GrantEPM_TRR based on the request.

For example, as discussed below, for requests relating to adding a new transaction, the method 1455 may check whether the transaction exists in the distributed databases 189. If the request relates to retracting a transaction, the method 1455 may check that the transaction type permits the request and the request has not been performed before. If the processor determines at step 1480 that the request is invalid, the processor may generate a further request at step 1485 to revoke the identity of the node issued the request. The further request would be considered as an identity revocation request and will be processed at step 1490.

If the request is deemed to be valid at step 1480, the method 1455 proceeds to step 1490 to grant the request based on the transaction type. The request is granted by executing granting commands of GrantEPM or GrantEPM_TRR. In response to granting the request, step 1490 continues to send a message to the node confirming that the request has been granted and adding the transaction to the data structure at step 1495.

The node may add the transaction to the data structure using a tip selection protocol discussed with references to FIG. 13. For example, if the request was to add a new transaction to the braid, a new retractable or a non-retractable transaction is added to the braid depending on the type of the requested transaction. If the request was to convert a retractable transaction to a non-retractable transaction, a new non-retractable transaction associated with the retractable transaction identified in the request is added to the data structure. Conversely, if the request was to retract a retractable transaction, a new non-retractable transaction associated with the retractable transaction identified in the request is added to the data structure.

The method 1455 concludes on completion of step 1495.

Below are considered double-spending, splitting, and parasite chain attack scenarios in Cryptiot which aim at compromising transactions and the braid.

### Double-Spending Attack

FIG. 8 illustrates a double-spending attack scenario 800 in Cryptiot. In the double spending attack scenario, an attacker tries to outperform the Cryptiot network as follows:

(I) The attacker sends a payment to a service provider. This represents a payment functionality-based actual transaction 810.

(II) The attacker issues a double-spending transaction 820.

(III) The attacker expects that nodes will attach at most two transactions 830 and 840 to the double-spending transaction and the braid continues to grow from the transaction as well as the legitimate transaction with original payment to the service provider as illustrated in FIG. 8.

Let ptr₂ and v₂ be the tips pointer and verifier, respectively, for validating the double-spending transaction, which is available in the braid at time t₂. As the legitimate actual transaction has been verified and granted a tips pointer ptr₁ and a verifier v₁ by any of the distributed master nodes and is available in the braid at an earlier time t₁ than t₂, the service provider will not accept the double-spending transaction since (i) the legitimate actual transaction has already been validated and is available in the braid at t₁, (ii) ptr₁ and v₁ can be verified, and (ii) ptr₂ and v₂ cannot be verified since they were not granted by any of the distributed master nodes. Thus, the double-spending transaction cannot be validated by the service provider as well as other nodes and would be left alone in the braid without any attachment to it.

Accordingly, the double-spending attack can be prevented using a tips pointer and a verifier in Cryptiot. Additionally, if the identity of a node cannot be verified or the M-ECDH key used is invalid during the execution of DC-KEP, the properties of the well-behaved environment is violated and thus the DC-KEP stops and halts its execution, i.e. no tips pointer or a verifier is generated.

The attacker may manage to obtain a tips pointer and a verifier that validates the double-spending transaction, then the attack succeeds, however, the success probability of the attacker obtaining the tips pointer and verifier is negligible due to strong cryptographic key exchange protocols being used. Nonetheless, if two conflicting transactions appear in the braid, in some implementations, one can validate the tips pointer and verifier to choose between two conflicting transactions since the tips pointer is supported with Enc(⋅) and Mac(⋅) and the verifier is supported with XMSS_{Sign}(⋅), which uses the XMSS private key of a distributed master node.

### Splitting Attack

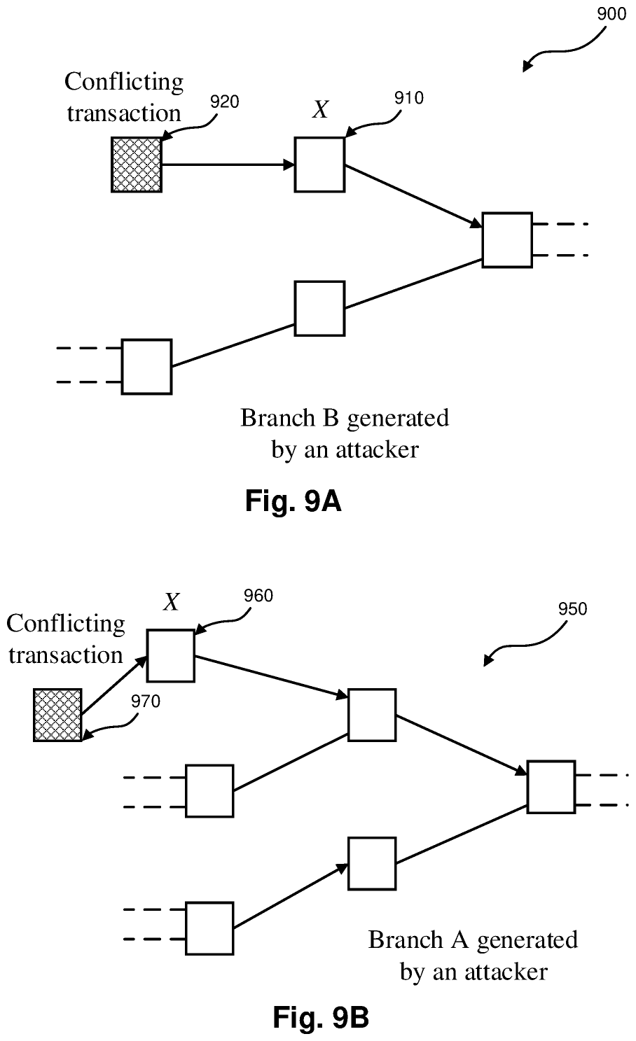

In the splitting attack scenario, an attacker attempts to split the braid into two different branches, generates meaningless transactions, and maintain the growth of the branches. To achieve this, the attacker may generate two conflicting transactions 920 and 970 and attach to the same previous transactions 910 and 960 in the two branches 900 and 950 as illustrated in FIG. 9. Then, the attacker hopes that nodes will attach new transactions to the branches. Thus, the attacker will also be able to carry out a double-spending attack.

To defend against the splitting attack, in some implementations, every node performs the following:
(I) Compute Hash(X(attached)) and verify whether (X,Hash(X(attached))) exist in the braid and any of the distributed databases for on-braid and off-braid verifications, respectively, where X represents the transaction at the beginning of the split;
(II) Verify the value of the attachment weight between X and the parent transaction of X, i.e. the transaction X is attached to;
(III) If the verifications (I) and (II) above succeed, then X is a legitimate transaction;
(IV) Verify whether (Y₁,Hash(Y₁(attached))) exist in the braid and any of the distributed databases, where Y₁ represents the legitimate transaction of a double-spending transaction Y₂ and Y₁=Y₂. If the verification succeeds, this shows that nodes will not attach any new transaction to Y₂. In this case, verification of existence of (Y₂,Hash(Y₂(attached))) in the braid and any of the distributed databases will fail since Y₁ was attached to the braid at an earlier time than Y₂ and the verification of Y₂ by any of the distributed master nodes will fail since Y₁=Y₂ already exists. Thus, splitting attack is prevented.

Splitting the braid by the attacker is very difficult because of the on-braid and off-braid verifications, difficulties of reducing or increasing the size of double-spending transactions to satisfy the attachment weight, and network synchronisation issues from new transactions attached to the previous transaction X presented above. Furthermore, new transactions can be attached to X before the attacker finalises splitting the braid.

### Parasite Chain Attack

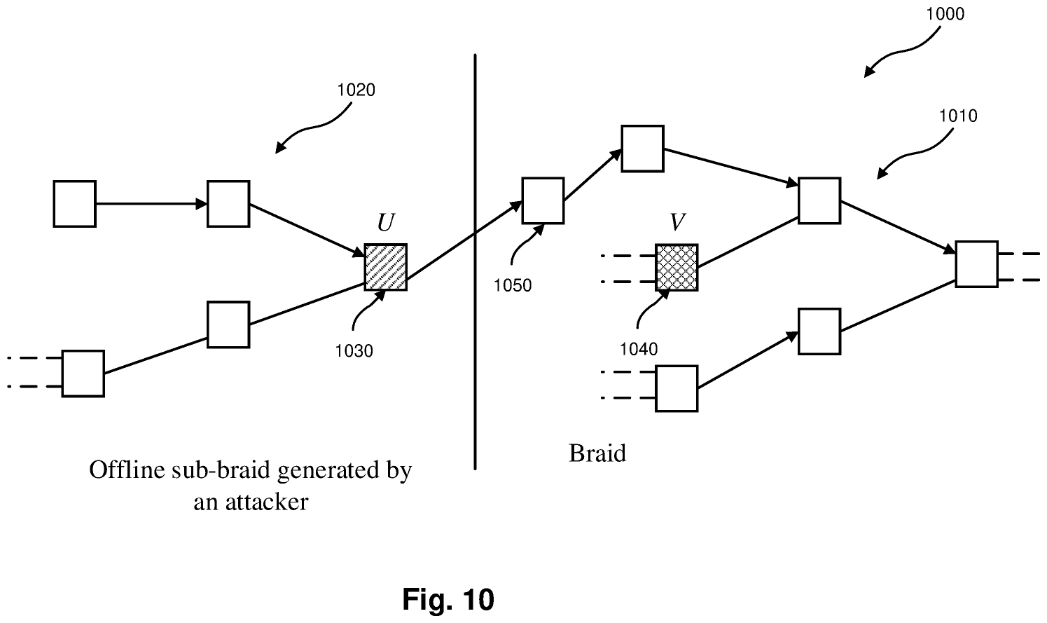

FIG. 10 shows a parasite chain attack 1000 in Cryptiot. In the parasite chain attack scenario, an attacker secretly generates an offline sub-braid 1020 in an offline manner and plant it as a bug in the braid 1020. A transaction U 1030 at the beginning of the sub-braid 1020 is attached to a transaction 1050 in the braid 1010 as illustrated in FIG. 10. At some point, the attacker issues a transaction V 1040 in the braid, where V is conflicting with U 1030 in the offline sub-braid 1020. The attacker continues to build the offline sub-braid 1020 to ensure that it has many transactions that can be chosen by nodes for attachments. Then, the attacker publishes the offline sub-braid 1020 online and hopes that the nodes will use U 1030 instead of V 1040 as well as other transactions in the offline sub-braid 1020, which is now a part of the braid 1010, for attaching new transactions in the future to disrupt the braid 1010. The attacker can also use U 1030 to carry out a double-spending attack in the future if U 1030 is successfully validated by a distributed master node.

In some implementations, to defend against the parasite chain attack, every transaction in the braid 1010 is validated by a node before it attaches a new attachment to the braid to prevent any disruption in the braid. Additionally, in some implementations, every distributed master node grants a tips pointer and a verifier to a new transaction as well as validates the previous transaction that the new transaction will be attached to in order to prevent the double-spending attack. Since all nodes follow the strategy of attaching a transaction to a selected tip as well as the DC-KEP for granting the tips pointer and verifier based on the commands available to them as specified in the protocol suite discussed above, all nodes validate transactions before attaching to the braid and every distributed master node validates transaction before granting a tips pointer and a verifier. Accordingly, the likelihood of a successful parasite chain attack on the braid discussed above is low.

### INDUSTRIAL APPLICABILITY

The arrangements described are applicable to the computer and data processing industries and particularly for the distributed ledger technologies.

The foregoing describes only some embodiments of the present invention, and modifications and/or changes can be made thereto without departing from the scope and spirit of the invention, the embodiments being illustrative and not restrictive.

It is to be noted that the discussions contained in the “Background” section should not be interpreted as forming part of the common general knowledge in the art.

(Australia Only) In the context of this specification, the word “comprising” means “including principally but not necessarily solely” or “having” or “including”, and not “consisting only of”. Variations of the word “comprising”, such as “comprise” and “comprises” have correspondingly varied meanings.

1. A method of controlling a state of accounts using a data structure storing a plurality of transactions representing the state of accounts, the method comprising:
receiving a request by a node of a plurality of nodes to create a transaction;
determining a type of the transaction based on the request;
determining, based on the determined type, whether to add the transaction to a data structure storing a plurality of transactions representing a state of accounts; and
in response to determining that the transaction is to be added to the data structure, storing the transaction in the data structure based on the determined type to control the state of accounts,
wherein the transaction is stored in the data structure using a link corresponding to the determined type, the determined type corresponding to a type from a plurality of types comprising a retractable transaction and a non-retractable transaction.

2. The method according to claim 1, wherein the transaction is added to the data structure in association with the determined type to control the state of accounts, wherein the transaction is added to the data structure using a Distributed Consensus-based Key Establishment protocol if the transaction is either a retractable transaction or a non-retractable transaction.

3. The method according to claim 1, further comprising utilizing the transaction without being added to the data structure if the determined type is a non-payment functionality transaction, wherein the non-payment functionality transaction is utilised using a Non-Consensus-based Key Establishment protocol.

4. The method according to claim 2, further comprising:
receiving a further request by the node to convert a retractable transaction from the plurality of transactions in the data structure to a non-retractable transaction;
identifying the retractable transaction in the data structure using the received further request;
adding a further non-retractable transaction associated with the identified transaction to the data structure using the Distributed Consensus-based Key Establishment protocol.

5. The method according to claim 1, further comprising:
receiving a retracting request by the node to retract a transaction in the data structure;
identifying a transaction in the data structure based on the retracting request;
determining if the identified transacting is retractable;
retracting the transaction from the data structure if the transaction is retractable; and
providing feedback to indicate to the node that the transaction is not retractable if the transaction is non-retractable.

6. The method according to claim 1, wherein a non-retractable transaction is associated with a directional link in the data structure and a retractable transaction is associated with a non-directional link in the data structure.

7. The method according to claim 1, wherein each transaction from the plurality of transactions is associated with a transaction weight value and each link connecting two transactions is associated with a link weight value.

8. The method according to claim 7, wherein the transaction weight value represents a total amount of work carried to process the respective transaction; and wherein the link weight value is based on the transaction weight value associated with at least one the transactions connected by said link.

9. The method according to claim 1, further comprising determining a tip of the data structure to attach the transaction.

10. The method according to claim 9, wherein the tip is determined based on Fuzzy Analytic Hierarchy Process (AHP).

11. The method according to claim 1, wherein each request comprises generating a mutually authenticated key based on a key establishment protocol selected based on the determined type of the transaction.

12. The method according to claim 1, wherein the data structure is an Acyclic Mixed Graph.

13. The method according to claim 1, wherein at least one of the plurality of nodes is an Internet of Things node.

14. The method according to claim 1, wherein the plurality of transactions comprises at least one payment-related transaction and at least one of identity creation transaction and identity revocation transaction.

15. A computer implemented system for controlling a state of accounts using a data structure storing a plurality of transactions representing the state of accounts, wherein the computer implemented system includes one or more processors configured to perform the method of claim 1.

16. A computer readable medium including executable instructions which configured one or more processors of a computer implemented system to control a state of accounts using a data structure storing a plurality of transactions representing the state of accounts, wherein execution of the executable instructions by the one or more processors configure the computerised system to perform the method of claim 1.

17. A computer readable storage medium storing a data structure for storing a plurality of transactions representing the state of accounts, the data structure comprising:
a root; and
a plurality of tips, each tip corresponding to a transaction from the plurality of transactions, the plurality of tips comprising a non-retractable tip representing a non-retractable transaction and a retractable tip representing a retractable transaction,
wherein the non-retractable tip is linked, using a non-retractable link to a first further tip from the plurality of tips and the retractable tip is linked using an retractable link to a second further tip from the plurality of tip, wherein the data structure is configured to enable establishment of a further non-retractable link for the retractable link associated with the retractable tip in response to a request to convert the retractable transaction to a non-retractable transaction.

18. The computer readable storage medium of claim 17, wherein a Distributed Consensus-based Key Establishment Protocol is used for adding transactions to the data structure based on a transaction type and a Non-Consensus-based Key Establishment protocol is used for exchanging transaction without adding to the data structure.

19. The computer readable storage medium of claim 17, wherein each tip is configured to have up to two child tips.

20. A method of controlling a state of accounts using a data structure storing a plurality of transactions representing the state of accounts, the method comprising:
receiving a request by a node of a plurality of nodes to add a transaction to a data structure storing a plurality of transactions representing a state of accounts;
determining a type of the transaction based on the request; and
adding the transaction in the data structure based on the determined type to control the state of accounts, wherein the transaction is added to the data structure using a link corresponding to the determined type, the determined type corresponding to a type from a plurality of types comprising a retractable transaction and a non-retractable transaction.
